(19) United States
(12) Patent Application Publication
(10) Pub. No.: US 2009/0239664 A1
(43) Pub. Date: Sep. 24, 2009

(54) Gaming Machine And Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/186,121

(22) Filed: Aug. 5, 2008

Related U.S. Application Data
(60) Provisional application No. 61/037,423, filed on Mar. 18, 2008.

(51) Int. Cl. A63F 13/00

(52) U.S. Cl. 463/31

(57) ABSTRACT

A gaming machine is provided with: a plurality of first video reels 31, 31, . . . , on which partial patterns of respective ones of plural kinds of patterns are arranged, respectively; and a plurality of second video reels 32, 32, . . . , on which plural kinds of symbols are arranged, respectively. Where a start button is pressed, a base game is started. After first video reels 31 and second video reels 32 are rotationally displayed, respectively, on a first liquid crystal display panel 11, the first video reels 31 are displayed in a stopped state. Where one entire pattern is completed by partial patterns displayed in a stopped state, a feature game which corresponds to the completed entire pattern is started. Thus, a player can intuitively recognize that a specific feature game is started. A first liquid crystal panel 11 displays an image which is indicative of the fact that a player's character 33 and an enemy's character 34 compete against each other, and each of them wins a game, while the completed entire pattern is used as a background. If the player's character 33 has won, a prize is established.

### CROSS-REFERENCE TO RELATED APPLICATIONS

This application claims priority of U.S. Provisional Application No. 61/037,423 filed on Mar. 18, 2008. The contents of this application are incorporated herein by reference in their entirety.

### BACKGROUND OF THE INVENTION

1. Field of the Invention

The present invention relates to a gaming machine and a control method of the gaming machine in which, where a predetermined condition is met in a base game, a feature game, which is different from the base game, is started.

2. Description of the Related Art

Conventionally, a slot machine is known in which, where a predetermined condition is met in a base game, a feature game which is different from the base game is started. This feature game is started in a case in which a predetermined number of specific symbols or more were displayed in the base game or in a case in which a combination of plural symbols, each of which is formed by employing characters, coincides with a predetermined word, for example. Such gaming machine is disclosed in the U.S. Pat. No. 6,168,523, for example.

However, it is difficult for a player to intuitively recognize whether or not the feature game is started, depending upon the presence or absence of a specific scatter symbol or whether or not a combination of specific scatter symbols is realized. Further, among from the feature games of which prizes are different from each other, for example, it is difficult for the player to intuitively recognize which of the feature games is started. As the result thereof, the player's reliability relative to games may be impaired.

### SUMMARY OF THE INVENTION

The present invention has been made in view of the above-described circumstance. It is an object of the present invention to provide a gaming machine and a control method of the gaming machine that enables a player to intuitively recognize that a specific feature game is started.

A first aspect of the present invention is directed to a game machine, including: a liquid crystal display section for displaying a plurality of first video reels, which rotate in one direction and on which partial patterns of respective ones of plural kinds of patterns are arranged, respectively, and a plurality of video reels through which the first video reels can be transparently seen, which rotate in a direction crossing said one direction, and on which plural kinds of symbols are arranged, respectively; an image storing section for storing data of an image indicating that a player's character and an enemy's character compete against each other in association with respective ones of plural kinds of patterns and either of the player's character and the enemy's character wins; a prize storing section for storing a prize to be established, in association with respective ones of the plurality of patterns; a start accepting section for accepting an operation of starting rotational display of the first video reels and rotational display of the second video reels; and a processor, which executes processes of: (a) starting a base game, and thereafter, randomly determining layout positions of partial patterns in correspondence with each of the first video reels, in a case where the start accepting section accepts the start operation; (b) randomly determining layout positions of symbols in correspondence with each of the second video reels; (c) rotationally displaying each of the first video reels; (d) rotationally displaying each of the second video reels; (e) displaying each of the first video reels in a stopped state, so that the partial patterns of each of the first video reels stop at the layout positions determined in the process (a); (f) displaying each of the second video reels in a stopped state, so that the symbols of each of the second video reels stop at the layout positions determined in the process (b), in a case where one entire pattern is incomplete by the partial patterns stopping at the layout positions; (g) establishing a prize corresponding to specific symbols, in a case where the symbols stopping thereat are the specific symbols; (h) starting a feature game corresponding to one entire pattern, and thereafter, randomly determining which of the player's character and the enemy's character wins, in a case where said one entire pattern is completed by the partial patterns stopping at the layout positions; (i) displaying an image indicating that the character determined at the process (h) wins, after the player's character and the enemy's character have competed against each other, based upon data stored in the image storing section in association with the completed entire pattern; and (j) establishing a prize stored in the prize storing section in association with the completed entire pattern, in a case where the character determined in the process (h) is the player's character.

According to the gaming machine, the first video reels are rotationally displayed in one direction, and the partial patterns of respective ones of plural kinds of patterns are arranged. On the other hand, through the second video reels, the first video reels can be transparently seen. The second video reels are rotationally displayed in the direction crossing such one direction in which the first video reels are rotationally displayed, and plural kinds of symbols are arranged. The liquid crystal display section displays pluralities of the first and second video reels, respectively.

The image storing section stores data of an image which is indicative of the fact that the player's character and the enemy's character compete against each other in association with respective ones of plural kinds of patterns, and then, either of them wins a game. Further, the prize storing section stores prizes to be established, in association with respective ones of the plural types of patterns.

The player staying at the game machine operates the start accepting section where rotational display of the first video reels and that of the second video reels are started. The processor executes the process (a) if the start accepting section accepts the operation. This process is executed, whereby a base game is started, and then, the layout positions of the partial patterns are randomly determined in correspondence with the first video reels. Further, the processor executes the process (b), whereby the symbol layout positions are randomly determined in correspondence with the second video reels.

The processor executes the processes (c) and (d), whereby the first and second video reels are rotationally displayed at the liquid crystal display section. Further, the processor executes the process (e), whereby the first video reels are displayed in a stopped state. At this time, the partial patterns of the first video reels stop at the layout positions determined in the process (a). If the layout positions of the partial patterns are appropriate, one entire pattern completes among from the plural types of patterns.

If one entire pattern is incomplete by the partial patterns that stopped at the layout positions determined in the process (a), the processor executes the processes (f) and (g), whereby the second video reels are displayed in a stopped state. At this time, the symbols of the second video reels stop at the layout positions determined in the process (b). Further, if specific symbols have stopped, prizes corresponding to the specific symbols are established. The thus established prizes are directly awarded to players or are awarded to the player after they are appropriately accumulated.

If one entire pattern is completed by the partial patterns that stopped at the layout positions determined in the process (a), the processor executes the process (h), whereby a feature game corresponding to the completed entire pattern is started. Thus, the player can intuitively recognize whether or not the feature game is started. Moreover, since the patterns and feature games correspond to each other, the player can intuitively recognize which of the feature games including different prizes is started. As the result thereof, the player's reliability relative to a game can be obtained.

Further, the processor executes the process (h), whereby which of the player's and enemy's characters win is randomly determined. Further, the processor executes the process (i), whereby an image is displayed on which the player's and enemy's characters compete against each other and the character determined in the process (h) wins. At this time, the liquid crystal display section displays an image, based upon the data stored in the image storing section in association with the completed entire pattern. Namely, the frames and the matchup images correspond to each other.

The processor executes the process (j), whereby prizes are established if the character determined in the process (h) is the player's character. The prizes established here are stored in the prize storing section in association with the completed entire patterns. Namely, the patterns and the prizes correspond to each other. As the result thereof, the player can be aware of the kinds and number of prizes by visually recognizing the patterns. The thus established prizes are directly awarded to the players or are awarded to the players after they are appropriately accumulated.

A second aspect of the present invention is directed to a game machine, wherein: the prize storing section stores a prize to be established, in association with respective ones of plural kinds of patterns and a combination of the player's character and the enemy's character; and the process (j) is a process of establishing the prize stored in the prize storing section in association with the completed entire pattern and a combination of the player's character and the enemy's character competing against each other in the process (i), in a case where the character determined at the process (h) is the player's character.

According to the gaming machine, the prize storing section stores prizes to be established, in association with respective ones of plural kinds of patterns and a combination of the player's and enemy's characters. The processor executes the process (j), whereby prizes are established if the character determined in the process (h) is the player's character. The thus established prizes are stored in the prize storing section in association with the completed entire pattern and a combination of the player's and enemy's characters competing against each other. Namely, the patterns, the matchup images, and the prizes correspond to each other. As the result thereof, the player can be aware of the kinds and number of prizes by visually recognizing the patterns or matchup images.

For example, if the player's character is a “cat” and the enemy's character is a “mouse”, the “cat” is stronger than the “mouse”, so that the player is given a small amount of prize money if the player's character has won. On the other hand, if the player's character is a “cat” and the enemy's character is a “dog”, the “cat” is weaker than the “dog”, so that the player is given a large amount of prize money if the player's character has won.

A third aspect of the present invention is directed to a gaming machine, including: a liquid crystal display section for displaying a plurality of first video reels, which rotate in one direction and on which partial patterns of respective ones of plural kinds of patterns are arranged, respectively, and a plurality of second video reels through which the first video reels can be transparently seen, which rotate in a direction crossing said one direction, and on which plural kinds of symbols are arranged, respectively; an image storing section for storing data of an image indicating that a player's character and an enemy's character compete against each other in association with respective ones of plural kinds of patterns and either of the player's character and the enemy's character wins; a prize storing section for storing a prize to be established, in association with respective ones of plural kinds of patterns and a combination of the player's character and the enemy's character; a start accepting section for accepting an operation of starting rotational display of the first video reels and rotational display of the second video reels; and a processor, which executes processes of: (a) starting a base game, and thereafter, randomly determining layout positions of partial patterns in correspondence with each of the first video reels, in a case where the start accepting section accepts the start operation; (b) randomly determining layout positions of symbols in correspondence with each of the second video reels; (c) rotationally displaying each of the first video reels; (d) rotationally displaying each of the second video reels; (e) displaying each of the first video reels in a stopped state, so that the partial patterns of each of the first video reels stop at the layout positions determined in the process (a); (f) displaying each of the second video reels in a stopped state, so that the symbols of each of the second video reels stop at the layout positions determined in the process (b), in a case where one entire pattern is incomplete by the partial patterns stopping at the layout positions; (g) establishing a prize corresponding to specific symbols, in a case where the symbols stopping thereat are the specific symbols; (h) starting a feature game corresponding to one entire pattern, and thereafter, randomly determining which of the player's character and the enemy's character wins, in a case where said one entire pattern is completed by the partial patterns stopping at the layout positions; (i) displaying an image indicating that the character determined at the process (h) wins, after the player's character and the enemy's character compete against each other, based upon data stored in the image storing section in association with the completed entire pattern; and (j) establishing a prize stored in the prize storing section in association with the completed entire pattern and a combination of the player's character and the enemy's character competing against each other in the process (i), in a case where the character determined in the process (h) is the player's character.

According to the gaming machine, the first video reels are rotationally displayed in one direction, and the partial patterns of respective ones of plural kinds of patterns are arranged. On the other hand, through the second video reels, the first video reels can be transparently seen. The second video reels are rotationally displayed in the direction crossing such one direction in which the first video reels are rotationally displayed, and plural kinds of symbols are arranged. The liquid crystal display section displays pluralities of the first and second video reels, respectively.

The image storing section stores data of an image which is indicative of the fact that the player's and enemy's characters compete against each other in association with respective ones of plural kinds of patterns, and then, either of them wins a game. Further, the prize storing section stores prizes to be established, in association with respective ones of plural kinds of patterns and a combination of the player's and enemy's characters.

The player staying at the game machine operates the start accepting section where rotational display of the first video reels and that of the second video reels are started. The processor executes the process (a) if the start accepting section accepts the operation. This process is executed, whereby a base game is started, and then, the layout positions of the partial patterns are randomly determined in correspondence with the first video reels. Further, the processor executes the process (b), whereby the symbol layout positions are randomly determined in correspondence with the second video reels.

The processor executes the processes (c) and (d), whereby the first and second video reels are rotationally displayed at the liquid crystal display section. Further, the processor executes the process (e), whereby the first video reels are displayed in a stopped state. At this time, the partial patterns of the first video reels stop at the layout positions determined in the process (a). If the layout positions of the partial patterns are appropriate, one entire pattern completes among from the plural types of patterns.

If one entire pattern is incomplete by the partial patterns that stopped at the layout positions determined in the process (a), the processor executes the processes (f) and (g), whereby the second video reels are displayed in a stopped state. At this time, the symbols of the second video reels stop at the layout positions determined in the process (b). Further, if specific symbols have stopped, prizes corresponding to the specific symbols are established. The thus established prizes are directly awarded to players or are awarded to the players after they are appropriately accumulated.

If one entire pattern is completed by the partial patterns that stopped at the layout positions determined in the process (a), the processor executes the process (h), whereby a feature game corresponding to the completed entire pattern is started. Thus, the player can intuitively recognize whether or not the feature game is started. Moreover, since the pattern and feature game correspond to each other, the player can intuitively recognize which of the feature games including different prizes is started. As the result thereof, the player's reliability relative to a game can be obtained.

Further, the processor executes the process (h), whereby which of the player's and enemy's characters win is randomly determined. Further, the processor executes the process (i), whereby an image is displayed on which the player's and enemy's characters compete against each other and the character determined in the process (h) wins. At this time, the liquid crystal display section displays an image, based upon the data stored in the image storing section in association with the completed entire pattern. Namely, the complete frames and the matchup images correspond to each other.

The processor executes the process (j), whereby prizes are established if the character determined in the process (h) is the player's character. The thus established prizes are stored in the prize storing section in association with the completed entire pattern and a combination of the player's and enemy's characters completing against each other in the process (i). Namely, the patterns, the matchup images, and the prizes correspond to each other. As the result thereof, the player can be aware of the kinds and number of prizes, by visually recognizing the patterns or matchup images.

For example, if the player's character is a “hunter” and the enemy's character is a “fox”, the “hunter” is stronger than the “fox”, so that the player is given a small amount of prize money if the player's character has won. On the other hand, if the player's character is a “hunter” and the enemy's character is a “village headman”, the “hunter” is weaker than the “village headman”, so that the player is given a large amount of prize money if the player's character has won a game.

A fourth aspect of the present invention is directed to a gaming machine, including: a plurality of mechanical reels, which rotate in one direction and on which partial patterns of respective ones of plural kinds of patterns are arranged, respectively; a liquid crystal display section for displaying a plurality of video reels through which the mechanical reels can be transparently seen, which rotate in a direction crossing said one direction, and on which plural kinds of symbols are arranged, respectively; an image storing section for storing data of an image indicating that a player's character and an enemy's character compete against each other, and either of the player's character and the enemy's character wins, in association with respective ones of plural kinds of patterns; a prize storing section for storing a prize to be established, in association with respective ones of plural kinds of patterns; a start accepting section for accepting an operation of starting rotation of the mechanical reels and rotational display of the video reels; and a processor, which executes processes of: (a) starting a base game, and thereafter, randomly determining layout positions of partial patterns in correspondence with each of the mechanical reels, in a case where the start accepting section accepts the start operation; (b) randomly determining layout positions of symbols in correspondence with each of the video reels; (c) rotating each of the mechanical reels; (d) displaying each of the video reels in a rotating state; (e) stopping each of the mechanical reels so that partial patterns of each of the mechanical reels stop at the layout positions determined in the process (a); (f) displaying each of the video reels in a stopped state, so that symbols of each of the video reels stop at the layout positions determined in the process (b), in a case where one entire pattern is incomplete by the partial patterns stopping at the layout positions (g) establishing a prize corresponding to specific symbols, in a case where the symbols stopping thereat are the specific symbols; (h) starting a feature game corresponding to one entire pattern, and thereafter, randomly determining which of the player's character and the enemy's character wins, in a case where said one entire pattern is completed by the partial patterns stopping at the layout positions; (i) displaying an image indicating that the character determined at the process (h) wins, after the player's character and the enemy's character compete against each other, based upon data stored in the image storing section in association with the completed entire pattern; and (j) establishing a prize stored in the prize storing section in association with the completed entire pattern and a combination of the player's character and the enemy's character competing against each other in the process (i), in a case where the character determined in the process (h) is the player's character.

According to the gaming machine, the mechanical reels rotate in one direction, and the partial patterns of respective ones of plural kinds of patterns are arranged. On the other hand, through the video reels, the mechanical reels can be transparently seen, and each of the video reels rotates in the direction crossing the rotational direction of each of the mechanical reels, and the liquid crystal display section displays a plurality of video reels.

The image storing section stores data of an image which is indicative of the fact that the player's and enemy's characters compete against each other in association with respective ones of plural kinds of patterns, and either of them wins a game. Further, the prize storing section stores prizes to be established, in association with respective ones of plural kinds of patterns.

The player staying at the gaming machine operates the start accepting section in the case of starting rotation of the mechanical reels and rotational display of the video reels. Where the start accepting section accepts the operation, the processor executes the process (a). This process is executed, whereby a base game is started, and thereafter, the layout positions of the partial patterns are randomly determined in correspondence with the mechanical reels. Further, the processor executes the process (b), whereby the layout positions of symbols are randomly determined in correspondence with the video reels.

The processor executes the processes (c) and (d), whereby the mechanical reels rotate, and thereafter, the video reels are rotationally displayed at the liquid crystal display section. Further, the processor executes the process (e), whereby the mechanical reels stop. At this time, the partial patterns of the mechanical reels stop at the layout positions determined in the process (a). Where the layout positions of the partial patterns are appropriate, one entire pattern completes from among plural kinds of patterns.

If one entire pattern is incomplete by the partial patterns that stopped at the layout positions determined in the process (a), the processor executes the processes (f) and (g), whereby the video reels are displayed in a stopped state. At this time, the symbols of the video reels stop at the layout positions determined in the process (b). Further, if specific symbols have stopped, prizes corresponding thereto are established. The thus established prizes are directly awarded to players, or alternatively, are awarded to the players after they are appropriately accumulated.

If one entire pattern is completed by the partial patterns that stopped at the layout positions determined in the process (a), the processor executes the process (h), whereby a feature game corresponding to the completed entire pattern is started. Namely, if the mechanical reels have stopped, when one entire pattern is incomplete, a base game is performed to the end. When one entire pattern completes, a feature game corresponding thereto is started. Thus, a player can intuitively recognize whether or not the feature game is started. Moreover, since the pattern and the feature game correspond to each other, the player can intuitively recognize which of the feature games with their different prizes is started. As the result thereof, the player's reliability relative to a game can be obtained.

In addition, the processor executes the process (h), whereby which of the player's and enemy's characters wins is randomly determined. Further, the processor executes the process (i), thereby displaying an image which is indicative of the fact that the player's and enemy's characters compete against each other, and thereafter, the character determined in the process (h) wins. At this time, the liquid crystal display section displays an image, based upon the data stored in the image storing section in association with the completed entire pattern. Namely, the pattern and the matchup image correspond to each other.

The processor executes the process (j), whereby a prize is established if the character determined in the process (h) is the player's character. The thus established prize is that which is stored in the prize storing section in association with the completed entire pattern. Namely, the patterns and prizes correspond to each other. As the result thereof, the player can be aware of the kinds and number of prizes, etc., by visually recognizing the patterns. The thus established prizes are directly awarded to players, or alternatively, are awarded to the player after they are appropriately accumulated.

A sixth aspect of the present invention is directed to a control method of a gaming machine which comprises: a liquid crystal display section for displaying a plurality of first video reels, which rotate in one direction and on which partial patterns of respective ones of plural kinds of patterns are arranged, respectively, and a plurality of second video reels through which the first video reels can be transparently seen, which rotate in a direction crossing said one direction, and on which plural kinds of symbols are arranged, respectively; an image storing section for storing data of an image indicating that a player's character and an enemy's character compete against each other in association with respective ones of plural kinds of patterns and either of the player's character and the enemy's character wins; a prize storing section for storing a prize to be established, in association with respective ones of the plurality of patterns; and a start accepting section for accepting an operation of starting rotational display of the first video reels and rotational display of the second video reels, said method including the steps of: (a) starting a base game, and thereafter, randomly determining layout positions of partial patterns in correspondence with each of the first video reels, in a case where the start accepting section accepts the start operation; (b) randomly determining layout positions of symbols in correspondence with each of the second video reels; (c) rotationally displaying each of the first video reels; (d) rotationally displaying each of the second video reels; (e) displaying each of the first video reels in a stopped state, so that the partial patterns of each of the first video reels stop at the layout positions determined in the process (a); (f) displaying each of the second video reels in a stopped state, so that the symbols of each of the second video reels stop at the layout positions determined in the process (b), in a case where one entire pattern is incomplete by the partial patterns stopping at the layout positions; (g) establishing a prize corresponding to specific symbols, in a case where the symbols stopping thereat are the specific symbols; (h) starting a feature game corresponding to one entire pattern, and thereafter, randomly determining which of the player's character and the enemy's character wins, in a case where said one entire pattern is completed by the partial patterns stopping at the layout positions; (i) displaying an image indicating that the character determined at the process (h) wins, after the player's character and the enemy's character have competed against each other, based upon data stored in the image storing section in association with the completed entire pattern; and (j) establishing a prize stored in the prize storing section in association with the completed entire pattern, in a case where the character determined in the process (h) is the player's character.

The gaming machine control method is capable of controlling the gaming machine of the present invention, for example.

### BRIEF DESCRIPTION OF THE DRAWINGS

FIGS. 1A and 1B are views showing characteristics of a gaming machine according to a first embodiment of the present invention;

FIG. 2 is a perspective view showing an appearance of the gaming machine according to the first embodiment of the present invention;

FIG. 3 is a schematic view showing exemplary first video reels displayed on a first liquid crystal display panel which is included in the gaming machine according to the first embodiment of the present invention;

FIG. 4 is a schematic view showing exemplary second video reels displayed on the first liquid crystal display panel that is included in the gaming machine according to the first embodiment of the present invention;

FIG. 5 is a schematic view showing an exemplary base game image (indicative of the fact that reels are displayed in a rotating state) which is displayed on the first liquid crystal display panel that is included in the gaming machine according to the first embodiment of the present invention);

FIG. 6 is a schematic view showing an exemplary base game image (indicative of the fact that reels are displayed in a rotating state) which is displayed on the first liquid crystal display panel that is included in the gaming machine according to the first embodiment of the present invention);

FIG. 7 is a schematic view showing an exemplary feature game image (indicative of a matchup between a player's character and an enemy's character) which is displayed on the first liquid crystal display panel that is included in the gaming machine according to the first embodiment of the present invention;

FIG. 8 is a schematic view showing an exemplary feature game image (indicative of the fact that the player's character has won) which is displayed on the first liquid crystal display panel that is included in the gaming machine according to the first embodiment of the present invention;

FIG. 9 is a schematic view showing an exemplary feature game image (indicative of the fact that the enemy's character has won) which is displayed on the first liquid crystal display panel that is included in the gaming machine according to the first embodiment of the present invention;

FIG. 10 is a schematic view showing an exemplary feature game image (indicative of a matchup between a strong player's character and a weak enemy's character) which is displayed on the first liquid crystal display panel that is included in the gaming machine according to the first embodiment of the present invention;

FIG. 11 is a schematic view showing an exemplary feature game image (indicative of a matchup between a weak player's character and a strong enemy's character) which is displayed on the first liquid crystal display panel that is included in the gaming machine according to the first embodiment of the present invention;

FIG. 12 is a schematic view showing one example of data stored in a pattern table included in the gaming machine according to the first embodiment of the present invention;

FIGS. 13A and 13B are schematic views each showing an example of data stored in a feature game-destined prize table which is included in the gaming machine according to the first embodiment of the present invention;

FIG. 14 is a block diagram depicting a configuration of essential portions in the gaming machine according to the first embodiment of the present invention;

FIG. 15 is a block diagram depicting a configuration of essential portions on a sub-control board which is included in the gaming machine according to the first embodiment of the present invention;

FIG. 16 is a flowchart showing procedures for executing game control processing in the gaming machine according to the first embodiment of the present invention;

FIGS. 17A and 17B are flowcharts showing a subroutine of procedures for executing base game play processing in the gaming machine according to the first embodiment of the present invention;

FIG. 18 is a flowchart showing a subroutine of procedures for executing feature game play processing in the gaming machine according to the first embodiment of the present invention;

FIG. 19 is a perspective view showing an appearance of a gaming machine according to a second embodiment of the present invention;

FIG. 20 is a block diagram depicting a configuration of essential portions of the gaming machine according to the second embodiment of the present invention; and

FIG. 21 is a flowchart showing a subroutine of procedures for executing base game play processing in the gaming machine according to the second embodiment of the present invention.

### DESCRIPTION OF THE PREFERRED EMBODIMENTS

### 1. First Embodiment

### 1-1. Overview of the Present Invention

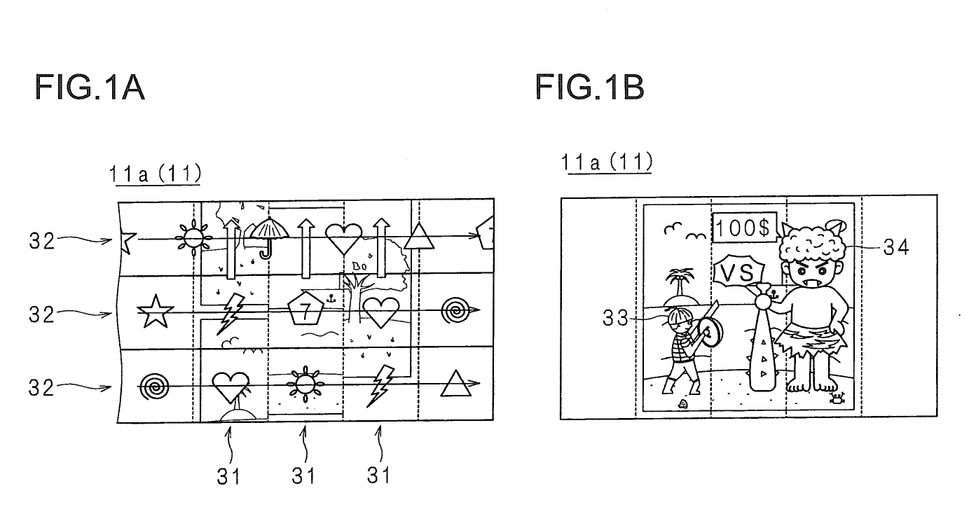

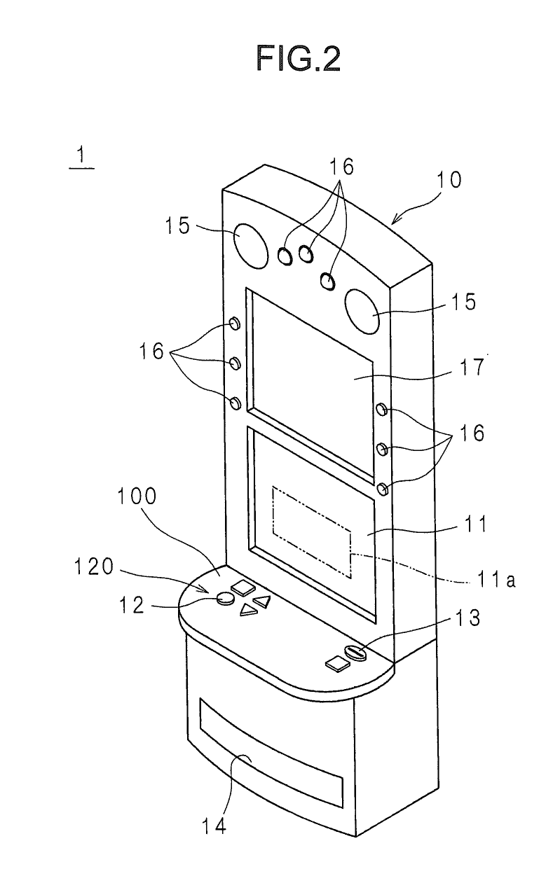

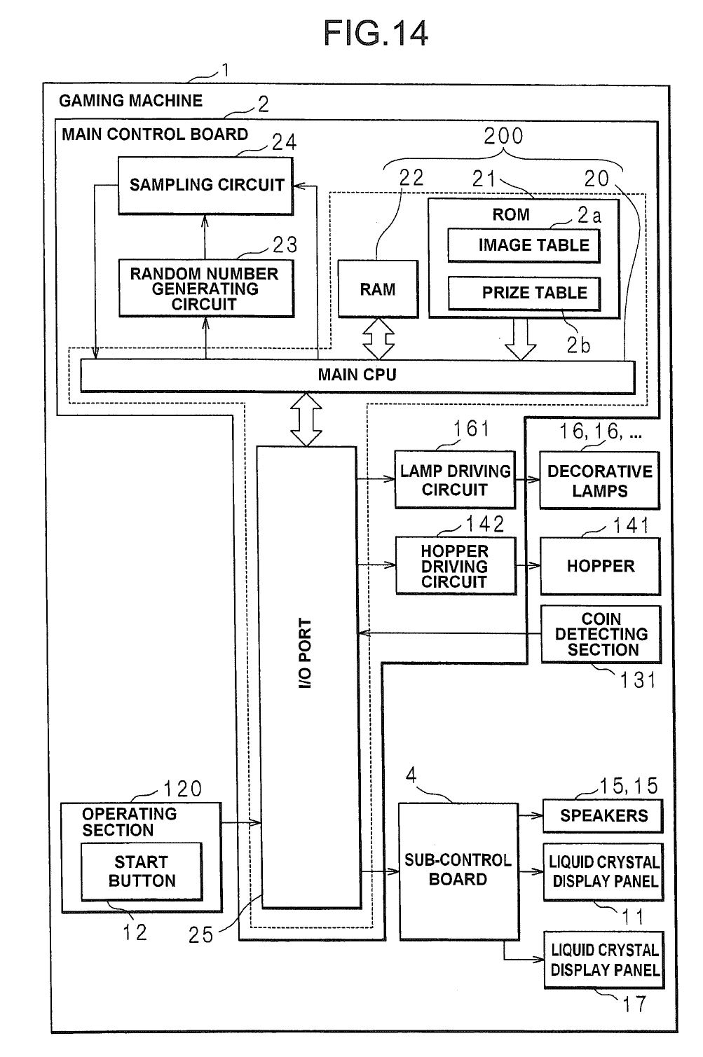

Hereinafter, embodiments of the present invention will be described with referring to the drawings. FIGS. 1A and 1B are views each showing characteristics of a gaming machine according to a first embodiment of the present invention. A gaming machine 1 (see FIGS. 2 and 14) is provided with a first liquid crystal display panel 11. The first liquid crystal display panel 11 functions as a liquid crystal display section. As shown in FIG. 1A, the first liquid crystal display panel 11 displays pluralities of first video reels 31, 31, . . . and second video reels 32, 32 . . . , respectively. In the present embodiment, the first video reels 31, 31, . . . and the second video reels 32, 32, . . . are displayed on a three-by-three reels basis, respectively.

Each of the first video reels 31 is displayed in a rotating state in the direction indicated by the outline arrow shown in FIG. 1A (i.e., in an upward direction). Further, partial patterns of each of plural kinds of patterns are arranged on each of the first video reels 31. On the other hand, through the second video reels 32, the first video reels 31, 31, . . . , can be transparently seen, and each of the second video reels 32 is displayed in a rotating state in the direction indicated by the arrows orthogonal to that indicated by the outline arrows in FIG. 1A (i.e., in a rightward direction). Further, plural kinds of symbols are arranged on each of the second video reels 32.

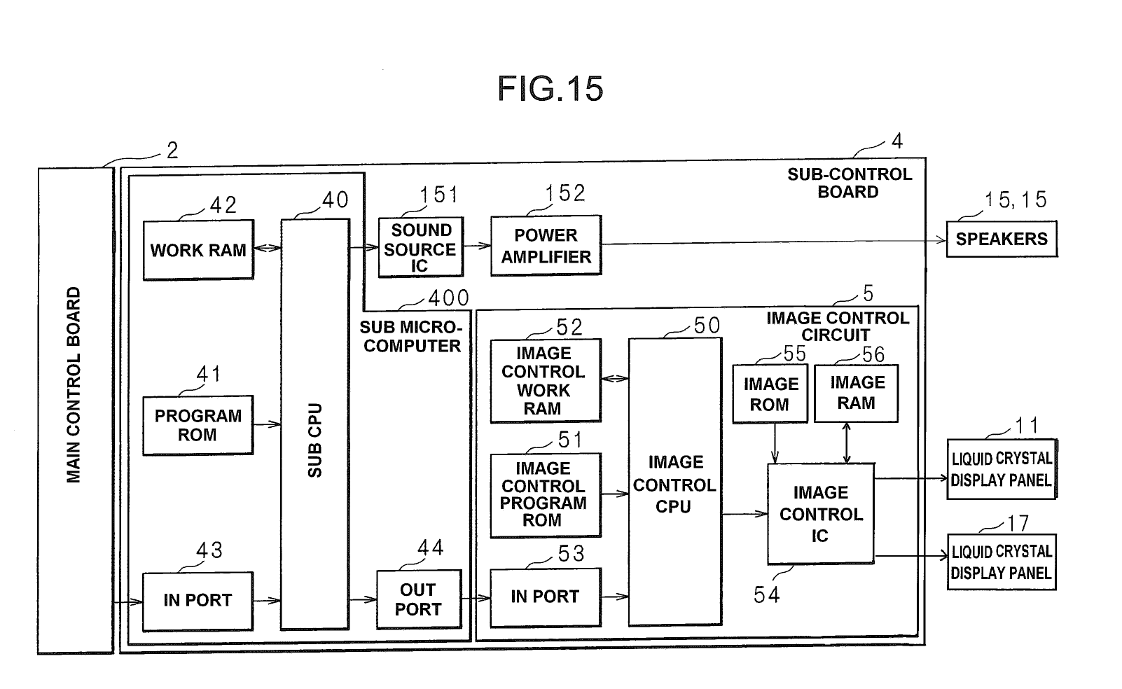

The gaming machine is provided with an image table 2a (see FIGS. 2 and 14). The image table 2a stores image identification information of image data which is indicative of the fact that either of a player's character and an enemy's character has won a matchup therebetween, in association with each of plural kinds of patterns. Further, the gaming machine 1 is provided with an image ROM 55 (see FIG. 15). The image ROM 55 stores image data per se in association with image identification information. Namely, the image table 2a and the image ROM 55 each function as an image storing section.

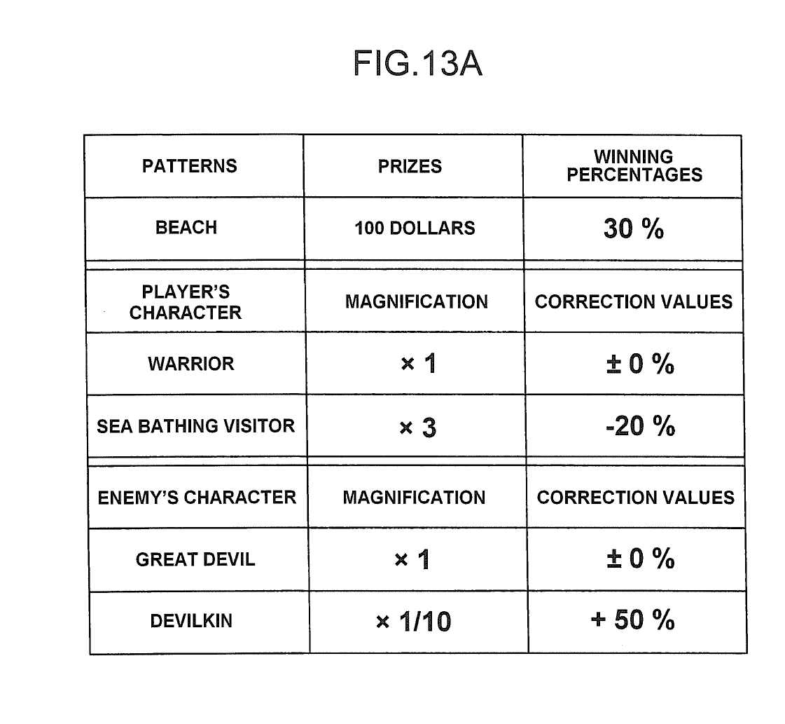

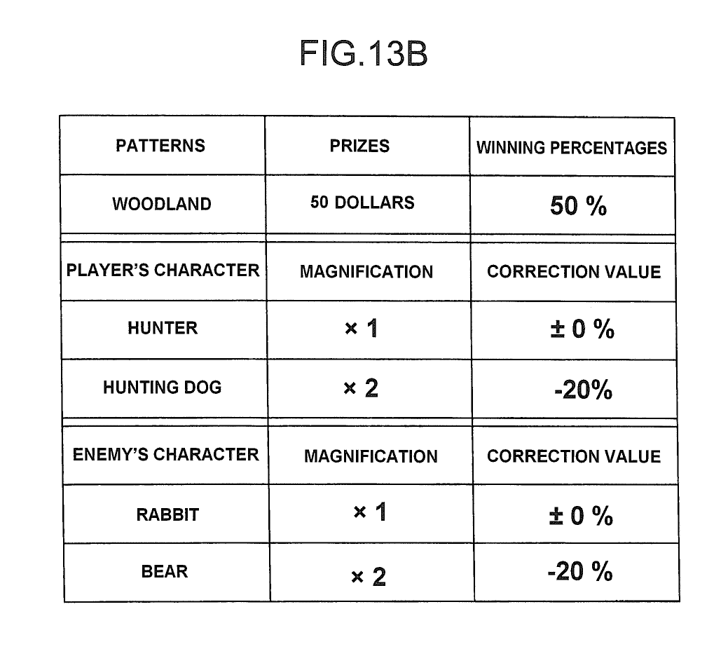

Further, the gaming machine 1 is provided with a feature game-destined prize table 2b (see FIGS. 13A and 13B and FIG. 14). The prize game 2b stores prizes to be established, in association with each of plural kinds of patterns and a combination between the player's character and the enemy's character. The prize table 2b functions as a prize storing section.

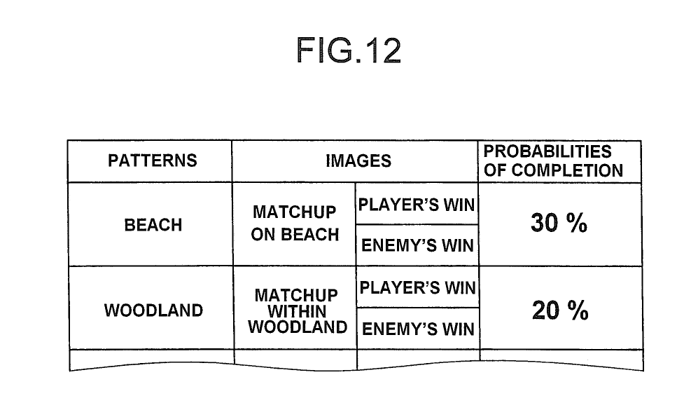

The gaming machine 1 is provided with a start button 12 (see FIGS. 12 and 14). A player staying at the gaming machine operates the start button 12 in the case of starting rotational display of the first video reels 31, 31, . . . and rotational display of the second video reels 32, 32, . . . . The start button 12 functions as a start accepting section.

Where the start button 12 is operated, a base game is started. Thereafter, the first liquid crystal display panel 11 displays a base game image which is indicative of the progress of the base game. Further, the layout positions of partial patterns are randomly determined in correspondence with each of the first video reels 31, and those of symbols are randomly determined in correspondence with each of the second video reels 32. As shown in FIG. 1A, further, on the first liquid crystal display panel 11, each of the first video reels 31 is displayed in a rotating state in the direction indicated by the outline arrows while each of the second video reels 32 is displayed in a rotating state in the direction indicated by the arrows. Thereafter, each of the first video reels is displayed in a stopped state. At this time, the partial patterns of each of the first video reels 31 stop at the determined layout position. Where the layout positions of the partial patterns are appropriate, one of plural kinds of patterns completes.

If one entire pattern is incomplete by the partial patterns that stopped at the determined layout positions, each of the second video reels 32 is displayed in a stopped state. At this time, the symbols of each of the second video reels 32 stop at the determined layout positions. If specific symbols have stopped, prizes corresponding thereto are established. The thus established prizes are directly awarded to players, or alternatively, are awarded to the players after they are appropriately accumulated. In the present embodiment, the above established prizes are directly awarded to the players in the form of coin payout. If no specific symbols have stopped, no prize is established.

If one entire pattern is completed by partial patterns that stopped at the determined layout positions, a feature game corresponding to the entire pattern is started. Thereafter, the first liquid crystal display panel 11 displays a feature game image which is indicative of the progress of the feature game. FIG. 1B illustrates a first liquid crystal display panel 11 which displays a feature game image indicative of the fact that a player's character 33 serving as a “warrior” competes against an enemy's character “great devil” in a background of a pattern indicative of a “beach”. Next, which one of the player's and enemy's characters 33 and 34 wins a game is randomly determined. After a winning character is determined, a feature game image (hereinafter, referred to as a win-loss image) is displayed which is indicative of the fact that a determined character wins in a matchup between the player's and enemy's characters 33 and 34.

In the feature game, an image is displayed based upon data stored in the image ROM 55 in association with an entire pattern completed in a base game. Namely, a pattern and a win-loss image correspond to each other. If a determined character is the player's character 33, a prize is established. The thus established prize is stored in a feature game-destined prize table 2b in association with a pattern completed in a base game and a combination between the player's and enemy's characters 33 and 34 competing against each other in the feature game.

As has been described above, if each of the first video reels 31 is displayed in a stopped state, when one entire pattern does not complete, a base game is performed to the end. When one entire pattern completes, a feature game corresponding to the completed entire pattern is started while the completion of the pattern is triggered. Thus, a player can intuitively recognize whether or not the feature game is started. Moreover, since the entire pattern completed in the base game and the win-loss image in the feature game correspond to each other, the player can intuitively recognize which of the feature games is started. As the result thereof, the player's reliability relative to games can be obtained. Further, since the patterns and win-loss images; and prizes correspond thereto, the player can be aware of kinds and number of prizes by visually recognizing patterns or win-loss images.

### 1-2. Configuration of the Gaming Machine

FIG. 2 is a perspective view showing an appearance of the gaming machine according to the first embodiment of the present invention. The gaming machine 1 is installed in an amusement place such as casino. The gaming machine 1 is provided with a cabinet 10 which houses electrical or mechanical parts for performing predetermined base and feature games. The base game corresponds to a slot game.

A rectangular first liquid crystal display panel 11 is arranged at the lower side of the frontal center of the cabinet 10. Although not shown, a backlight of the first liquid crystal display panel 11 is arranged at the depth of the first liquid crystal display panel 11. If a game is performed, a rectangular display area 11a is provided at the center of the first liquid crystal display panel 11. The display area 11a displays a game image which is indicative of the progress of a base game or a feature game. A display area other than the display area 11a displays an effect image for augmenting a game, an instruction for a player, a remaining number of coins accumulated in the gaming machine 1, and a value of BET, for example.

A second liquid crystal display panel 17 is arranged at the upper side of the frontal center of the cabinet 10. If a game is performed, the second liquid crystal display panel 17 displays an effect image for augmenting the game. Each of the liquid crystal display panels 11, 17 displays an image which is based upon the data stored in the image ROM 55 (see FIG. 15).

At the frontal upper part of the cabinet 10, speakers 15, 15 are disposed to be spaced from each other at the right and left-sides. Further, a number of decorative lamps 16, 16, . . . are arranged at the frontal periphery of the cabinet 10. An operating console 100 intended for a player to operate the gaming machine 1 is provided at the frontal lower part of the cabinet 10. On the top face of the operating console 100, an operating section 120 operated by a player and a coin insertion slot 13 for a player to insert a coin are provided. At the lower part of the operating console 100, a coin tray 14 is provided. At the operating section 120, a start button 12 and various types of other operational buttons such as a BET button and a CASHOUT button are provided.

In the gaming machine 1 of the embodiment, coins are employed as gaming media. Other gaming media such as bills, securities, medals, tokens, electronic money, and tickets may be employed without being limitative thereto.

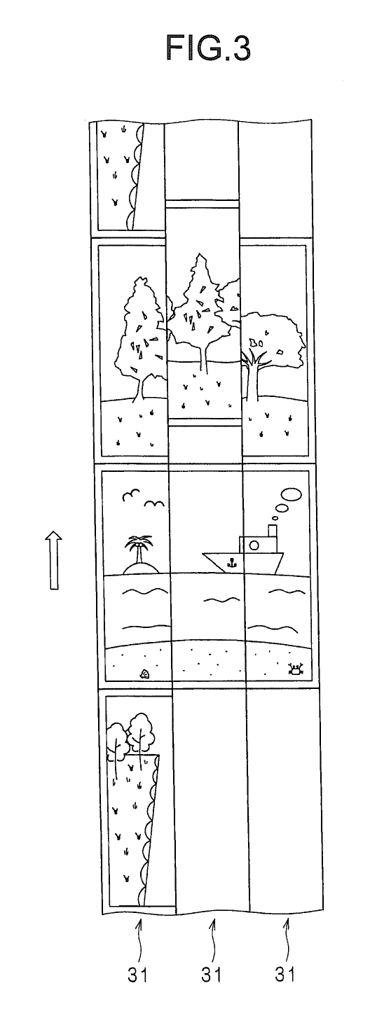

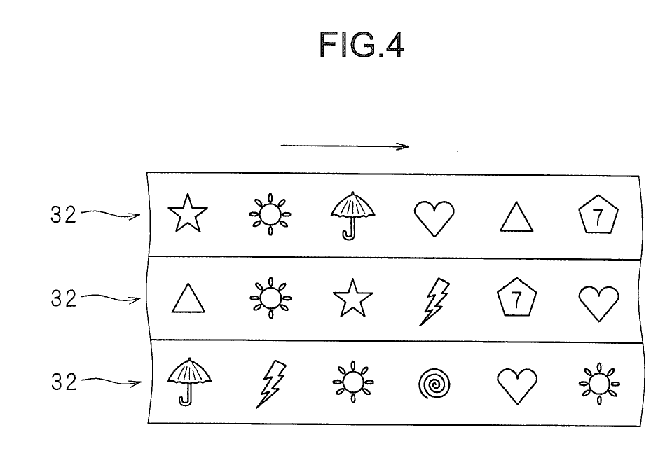

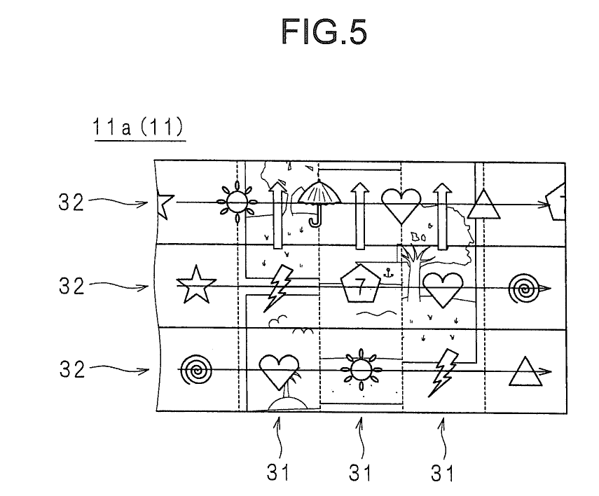

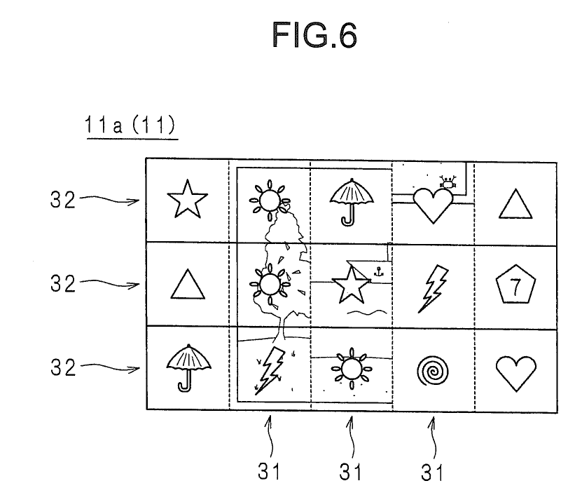

FIG. 3 is a schematic view showing exemplary first video reels displayed on a first liquid crystal display panel which is included in the gaming machine according to the first embodiment of the present invention. FIG. 4 is a schematic view showing exemplary second video reels displayed on the first liquid crystal display panel which is included in the gaming machine according to the first embodiment of the present invention. FIG. 5 is a schematic view showing an exemplary base game image (indicative of the fact that reels are displayed in a rotating state) which is displayed on the first liquid crystal display panel included in the gaming machine according to the first embodiment of the present invention, as is the case with FIG. 1A. FIG. 6 is a schematic view showing an exemplary base game image (indicative of the fact that reels are displayed in a stopped state) which is displayed on the first liquid crystal display panel that is included in the gaming machine according to the first embodiment of the present invention.

As shown in FIGS. 5 and 6, three video reels 31, 31, . . . and three second video reels 32, 32, . . . are displayed, respectively, inside of a display area 11a of a first liquid crystal display panel 11. Namely, the gaming machine 1 is a double reel-type gaming machine. Here, it is assumed that a square-shaped display unit (hereinafter, simply referred to as a “square”) is provided. This square has dimensions in which one symbol as described later can be internally arranged. The display area 11a has dimensions for five squares in the horizontal direction and three squares in the vertical direction.

As shown in FIG. 3, each of the first video reels 31 has dimensions for one square in the horizontal direction. Partial patterns of each of plural kinds of patterns are arranged on the first video reels 31, 31, . . . . In the present embodiment, these patterns include those which are representative of a “beach”, a “woodland”, and a “park”. Each of these patterns has dimensions for three squares in the horizontal direction and for three squares in the vertical direction.

Further, each of the patterns is divided into a partial pattern constituting a right side part thereof; a partial pattern constituting a right side part; and a partial pattern constituting a center part. These partial patterns are arranged on the rights-side, left-side, and central first video reels 31, 31, 31. Each of the partial patterns has dimensions for one square in the horizontal direction and for three squares in the vertical direction. In the following description, a partial pattern constituting the right side part of the entire pattern is referred to as a right-side partial pattern; that constituting the left-side part thereof is referred to as a left-side partial pattern; and that constituting the center thereof is referred to as a central partial pattern.

On the right first video reel 31, the right-side partial patterns of each of the entire patterns representative of the “beach”, “woodland”, and “park” are arranged to be vertically adjacent to each other or vertically spaced therefrom in appropriate length. Similarly, on the left first video reel 31, the left-side partial patterns of each of the entire patterns representative of the “beach”, “woodland”, and “park” are arranged to be vertically adjacent to each other or vertically spaced in appropriate length. On the central first video reel 31, the central partial patterns of each of the entire patterns representative of the “beach”, “woodland”, and “park” are arranged to be vertically adjacent to each other or vertically spaced therefrom in appropriate length.

Such first video reels 31, 31, . . . are arranged at the horizontal center part of the display area 11a, as shown in FIGS. 5 and 6, and thereafter, are rotationally displayed in an upward direction (indicated by the outline arrow in each of FIGS. 3 and 5) in the display area 11a. As the result thereof, each of the partial patterns is movably displayed in the upward direction.

As shown in FIG. 4, each of the second video reels 32 has dimensions for one square in the vertical direction. On each of the second video reels 32, plural kinds of symbols are arranged at equal intervals in the horizontal direction. In the present embodiment, these symbols are patterns representative of a “star”, a “heart”, a “convolution”, a “sun”, a “flash of lightning”, an “umbrella”, and a “triangle” and a pattern indicative of a number “7”. Such second video reels 32, 32, . . . are arranged entirely in the display area 11a, as shown in FIGS. 5 and 6, and are rotationally displayed in the rightward direction (indicated by the arrow in each of FIGS. 4 and 5). As the result thereof, each of the symbols is movably displayed in the rightward direction.

In the meantime, as shown in FIGS. 5 and 6, in the display area 11a, the second video reels 32, 32, . . . are displayed as if they were arranged at the frontal side of the first video reels 31, 31, . . . . In further detail, the first video reels 31, 31, . . . cannot be transparently seen through symbols arranged on each of the second video reels 32, whereas the first video reels 31, 31, . . . and the second video reels 32, 32, . . . are displayed in the display area 11a so that the first video reels 31, 31, . . . are transparently seen through portions at which symbols of each of the second video reels 32 are not arranged. As the result thereof, a player can easily visually recognize partial patterns arranged on the first video reels 31, 31, . . . and the symbols arranged on the second video reels 32, 32, . . . .

The symbols arranged on each of the second video reels 32 are made semitransparent, and thereafter, portions at which symbols of each of the second video reels 32 are not arranged are made transparent, whereby the first video reels 31, 31, . . . may be transparently seen through all of the second video reels 32.

In the gaming machine 1, first, a base game is performed. A player performs the base game by operating the operating section 20 shown in FIG. 2 while visually recognizing an image of the base game, which is displayed on the first liquid crystal display panel 11, and an effect image displayed on the second liquid crystal display panel 17.

Where the player operates the start button 12, each of the first video reels 31 is rotationally displayed in the upward direction, and each of the second video reels 32 is rotationally displayed in the rightward direction, as shown in FIG. 5, in the display area 11a. Thus, each of the partial patterns is movably displayed in the upward direction, and each of the symbols is movably displayed in the rightward direction. The first video reels 31, 31, . . . , which were displayed in a rotating state, are displayed in a stopped state with a predetermined timing on a one-by-one reel basis. At this time, partial patterns arranged in each of the first video reels 31 are displayed in a stopped state in the display area 11. However, as to one of the first video reels 31, the entire portion of one partial pattern may be displayed in the display area 11a; part of one partial pattern may be displayed therein; or alternatively, a part of each of two partial patterns may be displayed therein.

As to all of the three first video reels 31, 31, . . . , where the entirety of one partial pattern is displayed in the display area 11a and all of the displayed three partial patterns are those which belong to patterns of a same kind, one entire pattern completes in the display area 11a. If one entire pattern completes in the display area 11a, a feature game which is different from a base game is started as described later. On the other hand, with respect to at least one of the first video reels 31, if the entirety of one partial pattern is not displayed in the display area 11a, or alternatively, if at least one of the displayed three partial patterns does not belong to patterns of the same kind, one entire pattern does not complete in the display area 11a.

FIG. 6 illustrates a case in which, in each of the first video reels 31, 31 . . . , the display area 11a displays therein a part of the left-side partial pattern of an entire pattern representative of a “beach”; the entirety of the left-side partial pattern of an entire pattern representative of a “woodland”; and the entirety of the central partial pattern of an entire pattern representative of the “beach”. In the display area 11a shown in FIG. 6, although the left-side and central partial patterns of the entire patterns of a same kind are displayed in a stopped state, an entire pattern does not complete yet, since only one part of the right-side partial pattern is displayed in a stopped state. Assuming that the entirety of the right-side partial pattern is displayed in a stopped state, an entire pattern does not complete, since the left-side partial pattern is that which belongs to a pattern that is different from the right-side partial pattern and the central partial pattern.

If one entire pattern does not complete in the display area 11a, a base game is continued. At this time, each of the second video reels 32, 32, . . . , which were displayed in a rotating state, is displayed in a stopped state with a predetermined timing on a one-by-one reel basis. FIG. 6 illustrates a case in which “7” and “convolute” symbols are displayed in a stopped state on a one-by-one symbol basis; “star”, “umbrella”, “heart”, “triangle”, and “flash of lightning” symbols are displayed in a stopped state on a two-by-two symbols basis; and three “sun” symbols are displayed in a stopped state.

In the present embodiment, where three or more symbols of a same kind are displayed in a stopped state in a display area 11a, a winning prize is awarded to a player. At this time, a predetermined number of coins are paid out from the coin tray 14 shown in FIG. 2. Namely, all of the symbols of the present embodiment correspond to scatter symbols. If more than three symbols, i.e., four or more symbols of a same kind are displayed in a stopped state, more coins may be paid out in proportion thereto. Further, as to plural kinds of symbols, if three or more symbols of a same kind are displayed in a stopped state as well, the number of coins to be paid out may be multiplied. On the other hand, if only two or less symbols of a same kind are displayed in a stopped state in the display area 11a, no coin is paid out to the coin tray 14.

Since three “sun” symbols are displayed in the display area 11a shown in FIG. 6, coins are given to a player. Assuming that one of the three “sun” symbols is replaced with a “convolute” or “7” symbol, no coin is given to the player.

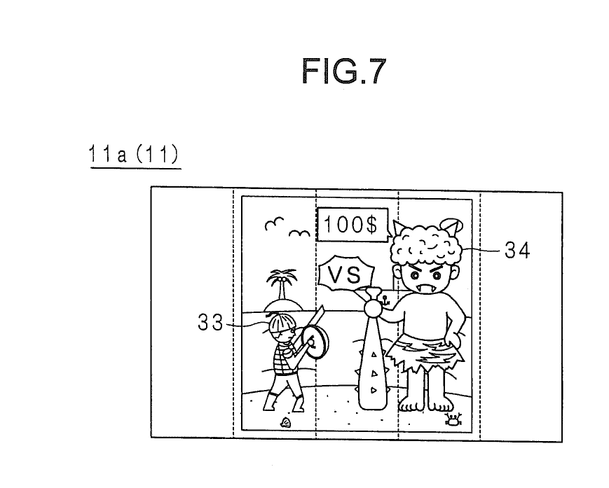

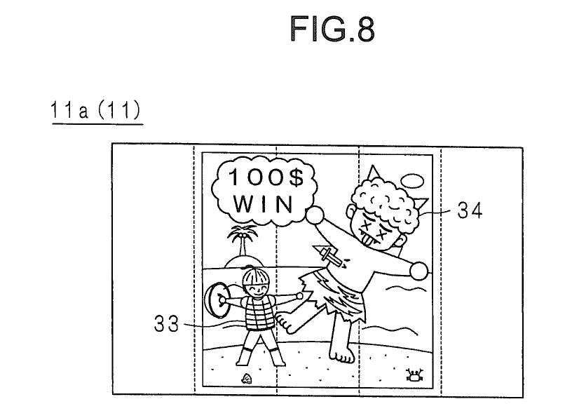

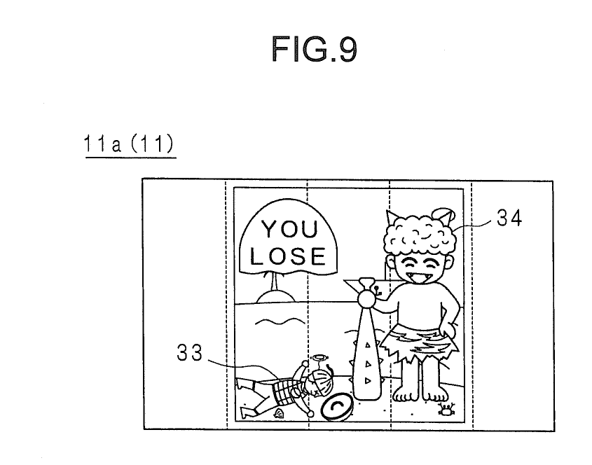

FIG. 7 is a schematic view showing an exemplary feature game image (indicative of a matchup between a player's character and an enemy's character) which is displayed on a first liquid crystal display panel included in the gaming machine according to the first embodiment of the present invention, as is the case with FIG. 1B. Further, FIG. 8 is a schematic view showing an exemplary feature game image (indicative of the fact that a player's character has won) which is displayed on the first liquid crystal display panel that is included in the gaming machine according to the first embodiment of the present invention; and FIG. 9 is a schematic view showing an exemplary feature game image (indicative of the fact that the enemy's character has won) which is displayed on the first liquid crystal display panel that is included in the gaming machine according to the first embodiment of the present invention;

A feature game is started where one entire pattern completes in the display area 11a. Since no symbol is used in the feature game of the embodiment, the second video reels 32, 32, . . . are not displayed in the display area 11a after the feature game is started. FIG. 7 illustrates a case in which, on the first video reels 31, 31, . . . , all of partial patterns of an entire pattern representative of a “beach” are displayed in a stopped state in the display area 11a. Namely, one entire pattern completes in the display area 11a shown in FIG. 7. Therefore, a feature game is started in the display area 11a shown in FIG. 7.

While no partial patterns are directly used in the feature game of the embodiment, the entire patterns completed in a base game are used as a background as shown in FIGS. 7 to 9. Where a feature game is started, the completed image may be erased without being used as a background, or alternatively, may be used as a background, in a state in which they are obscured by reducing luminance or applying shading thereto.

As a foreground of a feature game image, an image is displayed which is indicative of the fact that a player's character and an enemy's character compete against each other, and thereafter, either of them wins a game. FIG. 7 shows a feature game image which is indicative of the fact that the player's character 33 and the enemy's character 34 compete against each other while a graphic pattern representative of a “beach” is used as a background. The player's character 33 introduced herein is an armored “warrior” taking a sword and a shield, and the enemy's character 34 is a frightful “great devil”. As a feature game image shown in FIG. 7, further, prize money “100 dollars” is also displayed which a player wins if the player's character has won a game.

FIG. 8 shows a feature game image which is indicative of the fact that the player's character 33 wins against the enemy's character 34 while a pattern representative of a “beach” is used as a background. Further, prize money “100 dollars”, which a player wins, is also displayed in the feature game image shown in FIG. 8. On the other hand, FIG. 9 illustrates a feature game image which is indicative of the fact that the enemy's character 34 wins against the player's character 33 while a graphic pattern representative of a “beach” is used as a background. Prize money, which the player wins, is not displayed in the feature game image shown in FIG. 9. The feature game image as shown in FIG. 7 is displayed in the display area 11a, and thereafter, a feature game image as shown in either of FIGS. 8 and 9 is displayed.

Where the feature game image shown in FIG. 7 is displayed, when the feature game image is displayed in which the player's character 33 wins against the enemy's character 34, the player wins a prize. At this time, coins having a value for 100 dollars are paid out from the coin tray shown in FIG. 2. On the other hand, as shown in FIG. 9, when the feature game image is displayed in which the enemy's character 34 wins against the player's character 33, no coins are paid out to the coin tray 14. A feature game-destined prize table 2b (see FIGS. 13A and 13B) described later stores: a probability that the player's character 33 wins in the case of a matchup between the player's character 33 and the enemy's character 34; and the number of prizes, which a player wins by winning of the player's character 33.

In the meantime, the feature game of the embodiment includes other player's and enemy's characters completing against each other while a “beach” pattern is used as a background, apart from the player's and enemy's characters 33 and 34. Further, the player's and enemy's characters competing against each other while an entire pattern other than “beach” is used as a background are different from those completing while the “beach” pattern is thus used.

Moreover, a prize, which the player can win where the player's and enemy's characters 33 and 34 compete against each other while the “beach” pattern is used as a background, is occasionally different from that which the player can win where other player's and enemy's characters do the same. Further, a prize, which the player can win in the case of a matchup while the pattern “beach” is used as a background, is occasionally different from that which the player can win in the case of a matchup while a graphic pattern other than the “beach” is used as a background.

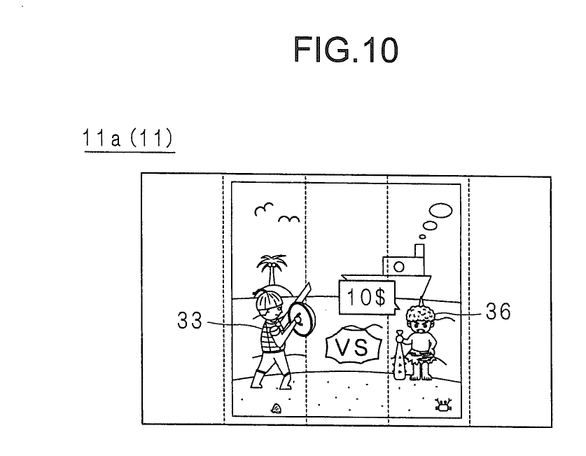

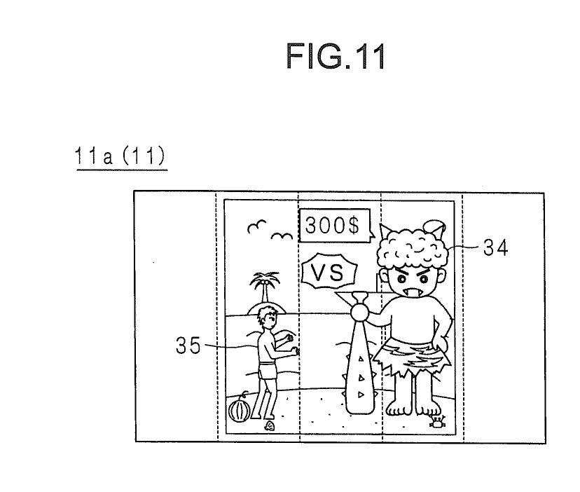

FIG. 10 is a schematic view showing an exemplary feature game image displayed on a first liquid crystal display panel (a matchup between the strong player's character and the weak enemy's character) which is included in the gaming machine according to the first embodiment of the present invention. FIG. 11 is a schematic view showing an exemplary feature game image displayed on a first liquid crystal display panel (a matchup between the weak player's character and the strong enemy's character) which is included in the gaming machine according to the first embodiment of the present invention. The feature game image shown in each of FIGS. 10 and 11 is equivalent to that shown in FIG. 7.

The feature game image shown in FIG. 10 includes an enemy's character 36 instead of the enemy's character 34 shown in FIG. 7. The enemy's character 36 is a cute “devilkin”. On the feature game image shown in FIG. 10, prize money “10 dollars”, which the player wins in the case where the player's character 33 has won a game, is displayed, the amount of which is lower than that of the prize money “100 dollars” displayed on the feature game image shown in FIG. 7. On the other hand, the feature game image shown in FIG. 11 is inclusive of the player's character 35 instead of the player's character 33 shown in FIG. 7. The player's character 35 is a “sea bathing visitor” wearing a swimming costume with no weapon. On the feature game image shown in FIG. 11, further, prize money “300 dollars”, which the player wins in the case where the player's character 35 has won a game, is displayed, the amount of which is higher than that of the prize money “100 dollars” displayed on the feature game image shown in FIG. 7.

The player's character 33 is a strong player's character and the player's character 35 is a weak player's character. Thus, the player's character 33 is more likely to win against an enemy's character than the player's character 35. Therefore, where the player's character 33 is displayed, the player can win a prize at a higher probability than that in the case where the player's character 35 is displayed. Instead, where the player's character 35 is displayed, the player can win many more prizes than those in the case where the player's character 33 is displayed.

On the other hand, the enemy's character 34 is strong and the enemy's character 36 is weak. Thus, the enemy's character 34 is more likely to win against a player's character than the enemy's character 36. Therefore, where the enemy's character 36 is displayed, the player can win a prize at a higher probability than that in a case where the enemy's character 34 is displayed. Instead, where the enemy's character 34 is displayed, the player can win many more prizes than that in the case where the enemy's character 36 is displayed.

In the meantime, although not shown, in a base game, if a pattern representative of a “woodland” has completed, a competing player's character is a strong “hunter” or a weak “hunting dog”, and an enemy's character is a strong “bear” or a weak “rabbit”.

FIG. 12 is a schematic view showing one example of data stored in a pattern table which is included in the gaming machine according to the first embodiment of the present invention. An image table 2a stores a ROM 21 described later (see FIG. 14). The image table 2a stores types of patterns (“patterns” in the figure), image identification information (“images” in the figure), and probabilities of completion. There are several kinds of patterns such as “beach” and “woodland”.

With respect to the “beach” pattern, for example, items of image identification information include data of a feature game image which is indicative of the fact that the player's character 33 and the enemy's character 34 compete against each other; data of a feature game image which is indicative of the fact that the player's character 33 wins; and data of a feature game image which is indicative of the fact that the enemy's character 34 wins. Using these items of image identification information, the data stored in an image ROM 55 described later (see FIG. 15) is read. A probability of completion denotes a probability of completion of each entire pattern. FIG. 12 illustrates a case in which a probability that a “beach” pattern completes is set at 30% and a probability that a “woodland” pattern completes is set at 20%.

FIGS. 13A and 13B are schematic views each showing one example of data stored in a feature game-destined prize table that is included in the gaming machine according to the first embodiment of the present invention. The feature game-destined prize table 2b is stored in a ROM 21 described later (see FIG. 14).

The prize table 2b stores: kinds of patterns (“patterns” in the figure); basic values of prizes established where player's characters have won (“prizes” in the figure); basic values of winning percentages that player's characters win (“winning percentages” in the figure) in association with each other. In addition, this prize table stores: types of player's characters (“player's characters” in the figure); magnifications to be multiplied for the basic values of prizes where the player's characters have won a matchup with enemy's characters (“magnifications” in the figure); and correction values of winning percentages where the player's characters compete against enemy's characters (“correction value” in the figure) in association with each other. Further, this table stores types of enemy's characters (“enemy's characters” in the figure); magnifications multiplied for the basic values of prizes where player's characters have won a matchup with the enemy's characters (“magnifications” in the figure); and the correction values of winning percentages where the player's characters compete against the enemy's characters in association with each other.

As shown in FIG. 13A, where a matchup takes place while the “beach” pattern is used as a background, the basic value of a prize established where a player's character has won is “100 dollars”, and the basic value of a winning percentage that a player's character wins is set at “30%”. Further, where a player's character 33 serving as a “warrior” has won a matchup with an enemy's character, a magnification multiplied for the basic value of a prize is “×1”, and the correction value of a winning percentage in the case where the player's character 33 competes against an enemy's character is set at “±0%”. Further, where the player's character has won a matchup with an enemy's character 34 serving as a “great devil”, the magnification multiplied for a basic value of a prize is set at “×1”, and a correction value of a winning percentage where the player's character competes against the enemy's character 34 is set at “±0%”.

As shown in FIG. 7, therefore, where the player's character 33 and the enemy's character 34 compete against each other while the “beach” pattern is used as a background, the conclusive prize is established as coins, the amount of which is equivalent to “100 dollars”, and the conclusive winning percentage is set at “30%”.

As shown in FIG. 13A, where the player's character 35 serving as a “sea bathing visitor” has won a matchup with an enemy's character, the magnification multiplied for the basic value of a prize is set at “×3”, and the correction value of a winning percentage in the case where the player's character 35 competes against the enemy's character 36 is set at “−20%”. Further, where a player's character has won a matchup with the enemy's character 36 serving as a “devilkin”, the magnification multiplied for the basic value of a prize is set at “×1/10”, and the correction value of a winning percentage in the case where a player's character competes against the enemy character 36 is set at “+50%”. Therefore, as shown in FIG. 10, where the player's character 33 and the enemy's character 36 compete against each other while the “beach” pattern is used as a background, the conclusive prize is established as coins, the amount of which is equivalent to “10 dollars”, and the conclusive winning percentage is set at “80%”.

In addition, as shown in FIG. 11, where the player's character 35 and the enemy's character 34 compete against each other while the “beach” pattern is used as a background, the conclusive prize is established as coins, the amount of which is equivalent to “300 dollars”, and the conclusive winning percentage is set at “10%”. Further, where the player's character 35 and the enemy's character 36 compete against each other while the “beach” pattern is used as a background, the conclusive prize is established as coins, the amount of which is equivalent to “30 dollars”, and the conclusive winning percentage is set at “60%”.

As shown in FIG. 13B, where a matchup takes place while the “woodland” pattern is used as a background, the basic value of a prize established where a player's character has won is set at “50 dollars”, and the basic value of a winning percentage that the player's character wins is set at “50%”. In addition, where the player's character “hunter” has won a matchup with an enemy's character, the magnification multiplied for the basic value of the prize is set at “×1”, and the correction value of a winning percentage where the player's character “hunter” competes against an enemy's character, the correction value of a winning percentage where the player's character “hunter” competes against the enemy's character is set at “±0%”. Further, where the enemy's character has won a matchup with the enemy's character “rabbit”, the magnification multiplied for the basic value of the prize is set at “×1”, and the correction value of a winning percentage where the player's character competes against the enemy's character “rabbit” is set at “±0%”. Therefore, where the player's character “hunter” and the enemy's character “rabbit” compete against each other while the “woodland” pattern is used as a background, the conclusive prize is established as coins, the amount of which is equivalent to “50 dollars”, and the conclusive winning percentage is set at “50%”.

As shown in FIG. 13B, where the player's character “hunting dog” has won a matchup with an enemy's character, the magnification multiplied for the basic value of the prize is set at “×2”, and the correction value of a winning percentage where the player's character “hunting dog” competes against the enemy's character is set at “−20%”. Further, where the player's character has won a matchup with the enemy's character “bear”, the magnification multiplied for the basic value of a prize is set at “×2”, and the correction value of a winning percentage where the player's character competes against the enemy's character “bear” is set at “−20%”. Therefore, where the player's character “hunter” and the enemy's character “bear” compete against each other while the “woodland” pattern is used as a background, the conclusive prize is established as coins, the amount of which is equivalent to “100 dollars”, and the conclusive winning percentage is set at “30%”.

In addition, where the player's character “hunting dog” and the enemy character “rabbit” compete against each other while the “woodland” pattern is used as a background, the conclusive prize is established as coins, the amount of which is equivalent to “100 dollars”, and the conclusive winning percentage is set at “30%”. Furthermore, where the player's character “hunting dog” and the enemy character “bear” compete against each other while the “woodland” pattern is used as a background, the conclusive prize is established as coins, the amount of which is equivalent to “200 dollars”, and the conclusive winning percentage is set at “10%”.

FIG. 14 is a block diagram depicting a configuration of essential portions of the gaming machine according to the first embodiment of the present invention. The gaming machine 1 has a plurality of constituent elements, mainly a main control board 2 including a main microcomputer 200.

In addition to the main microcomputer 200, the main control board 2 has a random number generating circuit 23, a sampling circuit 24, an I/O port 25, a hopper driving circuit 142, and a lamp driving circuit 161. To the I/O port 25, an operating section 120, a coin detecting section 131, a hopper driving circuit 142, a lamp driving circuit 161, and a sub-control board 4 are connected. To the sub-control board 4, speakers 15, 15 and liquid crystal display panels 11, 17 are connected. To the hopper driving circuit 142, a hopper 141 is connected. To the lamp driving circuit 161, decorative lamps 16, 16, . . . are connected.

The main microcomputer 200 has a main CPU 20, a ROM 21, and a RAM 22. To the main CPU 20, the ROM 21, the RAM 22, the random number generating circuit 23, the sampling circuit 24, and the I/O port 25 are connected. To the random number generating circuit 23, the sampling circuit 24 is connected. The ROM 21 stores computer programs (hereinafter, simply referred to as “programs”) and permanent data used when executing the programs.

The data stored in the ROM 21 includes various types of tables such as a pattern table, an image table 2a (see FIG. 12), a feature game-destined prize table 2b (see FIGS. 13A and 13B), a feature game-destined random number table, a symbol table, a base game-destined prize table, and a base game-destined random number table. The pattern table stores: individual first reel identification information assigned to the first video reels 31; and partial-pattern identification information of partial patterns arranged on the first video reels 31. The partial-pattern identification information also includes identification information for identifying patterns to which partial patterns belong. The feature game-destined random number table stores the range of random numbers, probabilities of completion, and winning percentages in association with each other.

The symbol table stores: individual second reel identification information assigned to the second video reels 32; and symbol identification information of symbols arranged on the second video reels 32. The base game-destined prize table stores prizes awarded to players if specific symbols are displayed in a stopped state in the display area 11a. Specifically, the prize table stores various types of data so that, if three or more symbols of a same kind are displayed in a stopped state in the display area 11a, prizes are awarded to players, and the number of prizes corresponding to symbols of different kinds (i.e., the number of coins) is different.

The base game-destined random number table stores the range of random numbers and winning probabilities (i.e., probabilities that prizes are awarded to players) in association with each other by specific symbols allowed to award prizes to players. For example, the random number table stores various types of data so as to narrow the range of random numbers and lower the winning probabilities with respect to symbols allowed to award a large amount of prize money (i.e., a large number of coins) to players.

The main CPU 20 executes various types of processes in accordance with the programs and data stored in the ROM 21. Specifically, the main CPU 20 controls the entire equipment operation of the gaming machine 1 by inputting/outputting signals to/from other constituent elements directly or via the I/O port 25. The random number generating circuit 23 is controlled and actuated by means of the main CPU 20, and generates a predetermined range of random numbers. The sampling circuit 24 is controlled and actuated by means of the main CPU 20; samples any of the random number generated by the random number generating circuit 23, and inputs the sampled random numbers to the main CPU 20.

The RAM 22 temporarily stores the data and programs used when the main CPU 20 is actuated. For example, the RAM 22 stores the random numbers sampled by means of the sampling circuit 24. In addition, the RAM 22 stores: first-reel identification information of a respective one of three first video reels 31, 31, . . . ; partial-pattern identification information of the partial patterns which should stop in the display area 11a with respect to each of the first video reels 31; and layout position information in the vertical direction of the partial patterns that should stop in the display area 11a. Further, the RAM 22 stores: second-reel identification information of a respective one of three second video reels 32, 32, . . . ; symbol identification information of symbols which should stop in the display area 11a with respect to the second video reels 32; and layout position information in the horizontal direction of the symbols that should stop in the display area 11a.

The lamp driving circuit 161 outputs to decorative lamps 16, 16, . . . an effect signals for causing the decorative lamps 16, 16, . . . to perform an illumination effect under the control of the main CPU 20. The decorative lamps 16, 16, . . . , to which the effect signals were input, light or blink. The hopper driving circuit 142 drives the hopper 141 under the control of the main CPU 20. As the result thereof, the hopper 142 pays out a predetermined number of coins to the coin tray 14. The coin detecting section 131 detects a coin inserted into the coin insertion slot 13, and then, outputs a coin detection signal, which is indicative of a detection result, to the main CPU 20 via the I/O port 25. The main CPU 20 computes the number of coins inserted into the coin insertion slot 13, based upon the input coin detection signal.

From the operating section 120, where various types of operational buttons including the start button 12 are operated, operational signals corresponding to the operated operational buttons are output to the main CPU 20 via the I/O port 25. The main CPU 20 controls equipment operation of the gaming machine 1 in response to the inputted operational signals. For example, where the start button 12 is operated, the start signal corresponding to the start button 12 is output to the main CPU 20. The main CPU 20, to which the start signal was input, starts displaying the first video reels 31 in a rotating state and displaying the second video reels 32 in a rotating state, via the sub-control board 4 described later.

The main CPU 20 indirectly controls speakers 15, 15 and liquid crystal display panels 11, 17 by controlling a sub-CPU 40 (see FIG. 15) included in the sub-control board 4 (see FIG. 15). As the result thereof, an effect voice or a melodious sound, etc., is output from the speakers 15, 15, and the liquid crystal display panels 11, 17 display various types of images. Thus, a predetermined control signal is output from the main CPU 20 to the sub-CPU 40, via the I/O port 25 and the IN port 43 (see FIG. 15).

FIG. 15 is a block diagram depicting a configuration of essential portions of a sub-control board included in the gaming machine according to the first embodiment of the present invention. In the sub-control board 4, a control signal is input from the main control board 2, thereby executing display control of each of the liquid crystal display panels 11, 17 and voice output control of the speakers 15, 15. The sub-control board 4 is a circuit board, which is different from that constituting the main control board 2, and consists essentially of a sub-microcomputer 400.

First, connection statuses of constituent elements will be described. The sub-microcomputer 400 has a sub CPU 40, a program ROM 41, a work RAM 42, an IN port 43, and an OUT port 44. To the sub CPU 40, the program ROM 41, the work RAM 42, the IN port 43, and the OUT port 44 are connected. The OUT port 44 is connected to an IN port 53 of an image control circuit 5 described later. The IN port 43 is connected to an I/O port 25 of the main control board 2 (see FIG. 14).

The sub-control board 4 shown in FIG. 15 has a sound source IC 151, a power amplifier 152, and an image control circuit 5, in addition to the sub-computer 400. The sound source IC 151 is connected to the sub CPU 40, and the power amplifier 152 is connected to the sound source IC 151 and the speakers 15, 15. An image control circuit 5 has: an image control CPU 50; an image control program ROM 51; an image control work RAM 52; an IN port 53; an image control IC 54; an image ROM 55; and an image RAM 56. The image control CPU 50 is connected to the image control work RAM 52, the IN port 53, and the image control IC 54. To the image control IC 54, the image ROM 55 and the image RAM 56 are connected. To the image control IC 54, further, the liquid crystal display panels 11, 17 are connected.

Next, functions of constituent elements will be described. The program ROM 41 stores: the programs for actuating the sub CPU 40; and permanent data used when executing the programs. The sub-control board 4 is not provided with a random number generating circuit and a sampling circuit, whereas the program ROM 41 stores random sampling programs instead thereof.

The sub CPU 40 executes various types of processes in accordance with the programs and data stored in the program ROM 41, based upon a control signal input from the main control board 2. Specifically, the sub CPU 40 controls operations of constituent elements of the sub-control board 4, the speakers 15, 15 connected to the sub-control board 4, and liquid crystal display panels 11, 17, etc., by inputting/outputting signals from/to other constituent elements, directly or via the IN port 43 or OUT port 44. In addition, the sub CPU 40 executes random number sampling programs, thereby generating random numbers and sampling the generated random numbers. Further, the sub CPU 40 computes image display parameters, and then, outputs to the image control CPU 50 parameter signals which are indicative of the computed parameters.

The work RAM 42 temporarily stores the data and programs used when the sub CPU 40 is actuated. For example, the work RAM 42 stores the random numbers sampled by the sub CPU 40 executing the random number sampling programs. The sound source IC 151 is controlled by means of the sub CPU 40, and outputs an effect sound from the speakers 15, 15. The power amplifier 152 is an amplifier for amplifying the voice output from the speakers 15, 15.

The image control program ROM 51 of the image control circuit 5 stores image control programs and permanent data that is used when executing the image control programs. The permanent data is a determination table for determining the images to be displayed on the liquid crystal display panels 11, 17, for example. The image ROM 55 stores: data of base game images formed using dot data; data of feature game images; and data of effect images, etc.

The image control CPU 50 determines the contents of images to be displayed on the liquid crystal display panels 11, 17, in accordance with the image control programs and data stored in the image control program ROM 51. This determination is based upon the parameter signals input from the sub-microcomputer 400. The image control work RAM 52 temporarily stores the data and programs used when the image control CPU 50 is actuated.

The image control IC 54 reads image data from the image ROM 55 in accordance with the contents determined by the image control CPU 50; forms video images, based upon the read data; and then, outputs the resultant images to the liquid crystal display panels 11, 17. The liquid crystal display panels 11, 17 display the input video images. The image RAM 56 temporarily stores data used when the image control IC 54 is actuated. In further detail, in the image RAM 56, a memory area for storing data for displaying the first video reels 31 and a memory area for storing data for displaying the second video reels 32 are provided. The image control IC 54 forms video images by superimposing data read from each of the memory areas, and then, outputs the resultant images to the liquid crystal display panels 11, 17.

In this manner, the main CPU 20 causes the liquid crystal display panels 11, 17 to display required images via the sub CPU 40, the image control CPU 50, and the image control IC 54. Therefore, the burden of the main CPU 20 can be alleviated more significantly than that in a case in which the main CPU 20 directly controls the liquid crystal display panels 11, 17 to display required images.

### 1.3. Operation of the Gaming Machine

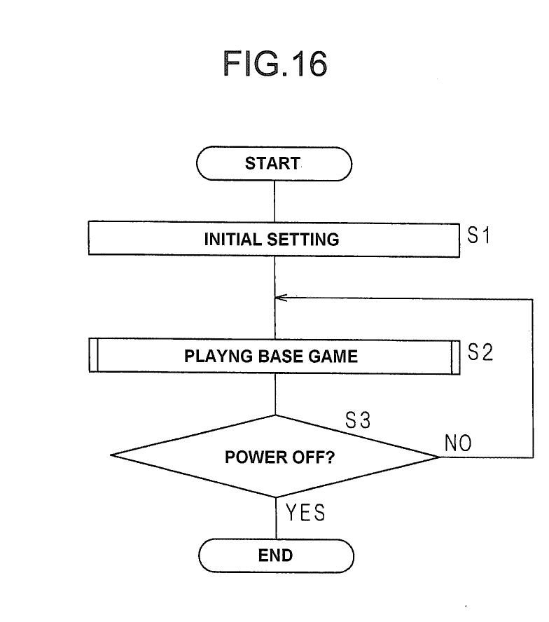

FIG. 16 is a flowchart showing procedures for executing game control processing in the gaming machine according to the first embodiment of the present invention. Where power is supplied to the gaming machine 1 by turning ON a power switch (not shown) of the gaming machine 1, the main microcomputer 200 is activated, and then, the main CPU 20 performs initial setting (step 1. Hereinafter, the word “Step” is abbreviated as “S”.)

The main CPU 20 at S1 executes a BIOS stored in the ROM 21, and then, decompresses, in the RAM 22, the compressed data incorporated in the BIOS. Then, this CPU executes the BIOS decompressed in the RAM 22, and diagnoses and initializes various types of peripherals. The main CPU 20 causes the RAM 22 to store the program and data stored in the ROM 21. In addition, this CPU controls the decorative lamps 16, 16, . . . via the lamp driving circuit 161, and then, starts an illumination effect. Further, this CPU controls speakers 15, 15 via the sub-control board 4, and then, starts a voice effect. Furthermore, the main CPU 20 controls the liquid crystal display panels 11, 17 via the sub-control board 4 to display predetermined images.

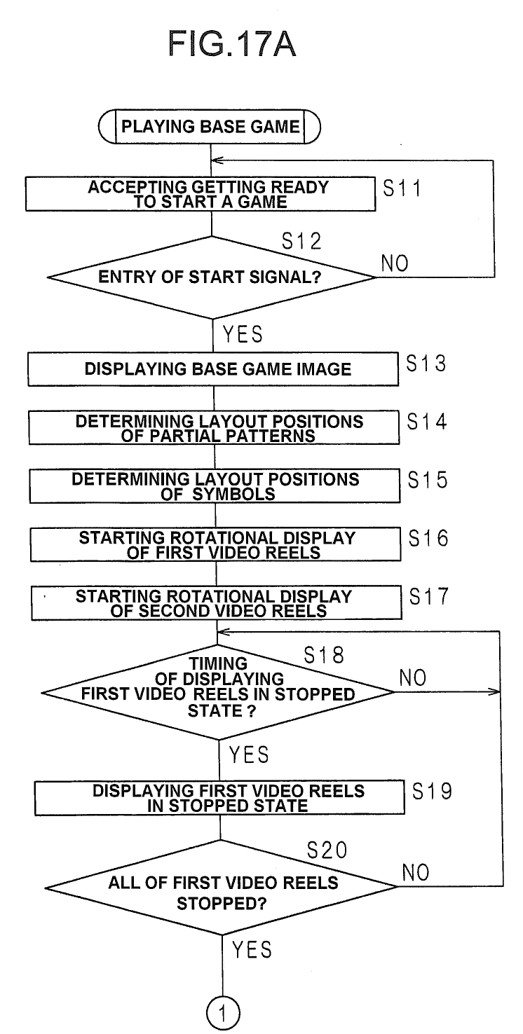

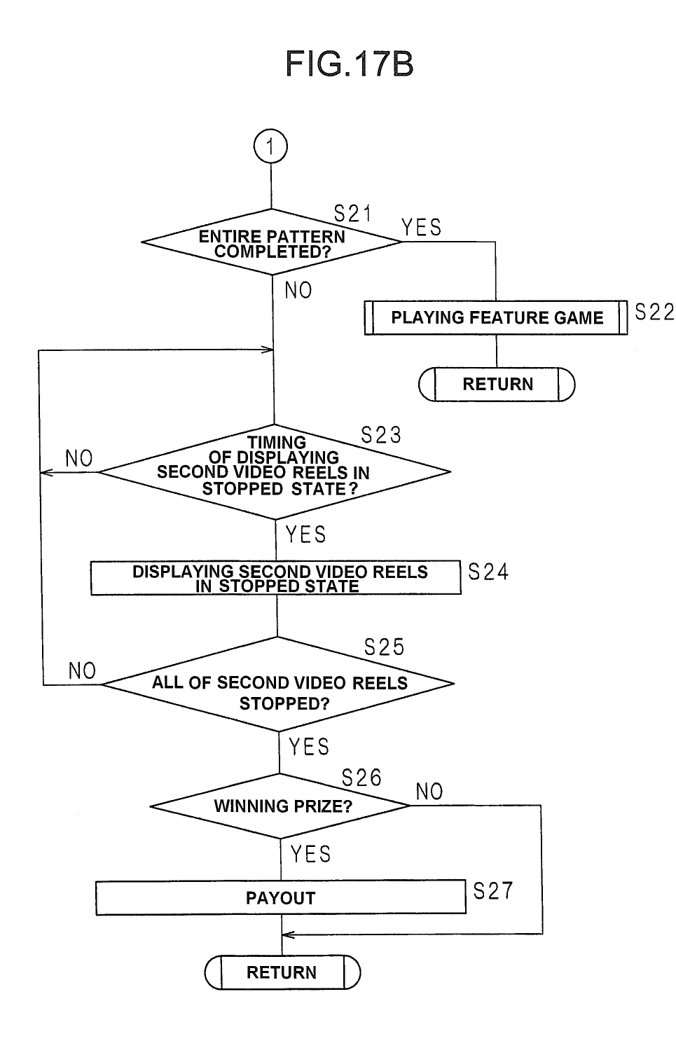

Next, the main CPU 20 invokes and executes a subroutine of base game play processing (see FIGS. 17A and 17B) (S2). After completion of the processing at S2, the main CPU 20 judges whether or not the power switch is turned OFF (S3). If the power switch is left to be ON (NO at S3), the processing at S2 is repeatedly executed. If the power switch is turned OFF (YES at S3), the main CPU 20 controls constituent elements of the gaming machine 1, terminates various types of operations (illumination and voice effects and image display or the like), and then, terminates game control processing.

FIGS. 17A and 17B are flowcharts each showing a subroutine of procedures for executing base game play processing in the gaming machine according to the first embodiment of the present invention. The main CPU 20 accepts getting ready to start a game (S11). Where the processing at S11 is executed, a player is ready to start a game by inserting a coin into the coin insertion slot 13, and thereafter, operating the operating section 120 (for example, increasing or decreasing BET by operating a BET button). After that, the player operates the start button 12.

Thus, although not shown, the main CPU 20 at S11 computes the number of coins inserted into the coin insertion slot 13, based upon a coin detection signal input from a coin detecting section 131, and then, causes a RAM 22 to store the computation result. Further, this CPU causes the RAM 22 to store a value of BET increased or decreased by operating the operating section 120.

Next, the main CPU 20 judges whether or not a start signal is input from the operating section 120 (S12). The judgment at S12 is made as to whether or not the start button 12 has accepted operation. Where the start signal is not input yet (NO at S12), the main CPU 20 reverts to S11, and then, continuously accepts getting ready to start a game. Where the start signal is input from the operating section 120 (YES at S12), i.e., where the start button 12 accepts operation, the main CPU 20, although not shown, computes the number of coins accumulated in the gaming machine 1 by subtracting the value of BET from the number of coins stored in a RAM 22. Then, the routine proceeds to S13.

The main CPU 20 starts a base game, thereby causing a display area 11a of a first liquid crystal display panel 11 (S13) to display a base game image, and then, to cause a second liquid crystal display panel 17 to display an effect image, although not shown. After executing the processing at S13, the base game image displayed in the display area 11a is an image which is indicative of the fact that the first video reels 31 and the second video reels 32 stop. The main CPU 20 at S13 outputs to a sub CPU 40 a control signal which is indicative of the fact that a base game is started at the gaming machine 1. The sub CPU 40, to which this control signal was input from the main CPU 20, outputs to an image control CPU 50 a parameter signal for causing the first liquid crystal display panel 11 to display a base game image.

The image control CPU 50, to which this parameter signal was input, determines the contents of a base game image to be actually displayed on the first liquid crystal display panel 11, and then, outputs to an image control IC 54 a determination signal which is indicative of the determined contents. The image control IC 54, to which this determination signal was input, reads from an image ROM 55, data of the base game image which is responsive to the input determination signal, forms the image, based upon the read data, and then, outputs the resulting image to the first liquid crystal display panel 11. As the result thereof, the first liquid crystal display panel 11 displays the base game image. Similarly, the second liquid crystal display panel 17 displays an effect image.

Next, the main CPU 20 randomly determines layout positions of partial patterns in correspondence with the first video reels 31 (S14) and randomly determines layout positions of symbols in correspondence with the second video reels 32 (S15). The layout positions of the partial patterns determined at S14 correspond to vertical layout positions of partial patterns to be displayed in a stopped state in the display area 11a if the first video reels 31 are displayed in a stopped state. In order to determine partial patterns at S14, the main CPU 20 refers to a pattern table, an image table 2a, and a base game-destined random number table, etc., stored in the ROM 21 and employs random numbers generated by a random number generating circuit 23 and sampled by a sampling circuit 24. The RAM 22 temporarily stores symbol identification information and layout position information of the determined symbols in association with the second reel identification information of the first video reels 31.

The layout positions of the symbols determined at S15 correspond to horizontal layout positions of symbols to be displayed in a stopped state in the display area 11a if the second video reels 32 are displayed in a stopped state. In order to determine the symbols at S15, the main CPU 20 refers to the symbol table and base game-destined random number table stored in the ROM 21 and employs random numbers generated by the random number generating circuit 23 and sampled by the sampling circuit 24. The RAM 22 temporarily stores the symbol identification information and layout position information of the determined symbols in association with the second reel identification information of the second video reels 32.

After completion of the processing at S15, the main CPU 20 starts rotational display of the first video reels 31 (S16) and starts rotational display of the second video reels 32 (S17). Thus, the main CPU 20 at S13 and S16 outputs an appropriate control signal to a sub CPU 40, thereby starting rotational display of the first video reels 31 and starting rotational display of the second video reels 32, via the sub CPU 40, the image control CPU 50, and the image control IC 54. After executing the processing at S16 and S17, the base game image displayed in the display area 11a is an image which is indicative of the fact that the first video reels 31 and the second video reels 32 are rotating, as shown in FIG. 5, for example.

Further, the main CPU 20 judges whether or not a timing, with which the first video reels 31 should be displayed in a stopped state, is established, based upon an elapsed time after starting rotational display of the first video reels 31 (S18). If not (NO at S18), the main CPU 20 repeats the judgment at S18 while continuing rotational display of the first video reels 31. An elapsed time after starting rotational display of the first video reels 31 may be clocked using a timer (not shown), or alternatively, may be clocked by counting the number of clocks input from a clock generator (not shown) to the main CPU 20.

With respect to at least one of the first video reels 31, a timing with which the first video reel 31 should be displayed in a stopped state is established (YES at S18), the main CPU 20 causes the first video reels 31 to be displayed in a stopped state so that the partial pattern determined at S14 with respect to the first video reel 31 to be displayed in a stopped state stops at the layout position determined at S14 (S19). Thus, the main CPU 20 at S19 outputs an appropriate control signal to the sub CPU 40 in accordance with the first reel identification information, partial-pattern identification information, and layout position information stored in the RAM 22, thereby displaying the first video reel 31 in a stopped state, via the image control CPU 50 and the image control IC 54.

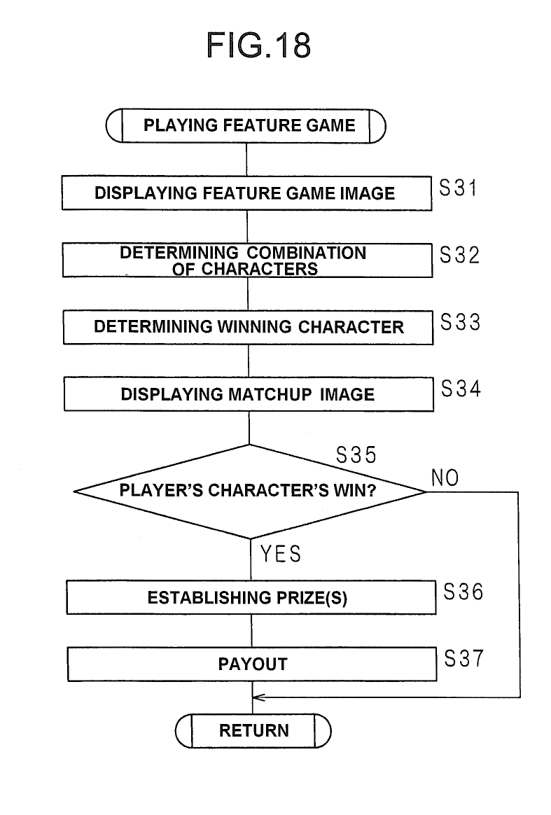

After the completion of the processing at S19, the main CPU 20 judges whether or not all of the three first video reels 31, 31, . . . are stopped (S20). If at least one of the first video reels 31 is still displayed in a rotating state (NO at S20), this CPU controls the routine revert to S18 and judges a timing of stopping rotation of such video reel in action. If all of the three first video reels 31, 31, . . . have been displayed in a stopped state (YES at S20), the main CPU 20 judges whether or not a pattern has completed (S21). Thus, the main CPU 20 refers to the partial-pattern identification information and layout position information stored in the RAM 22, and then, judges whether or not all of the partial patterns displayed in a stopped state in the display area 11a belong to one entire pattern and all of these partial patterns are displayed in a stopped state in the display area 11a.

Where a pattern has completed (YES at S21), the main CPU 20 invokes and executes a subroutine of feature game play processing (see FIG. 18) (S22). After the completion of the processing at S22, the main CPU 20 terminates base game play processing, and then, reverts to the former routine.

If one entire pattern is incomplete (NO at S21), the main CPU 20 judges whether or not a timing, with which the second video reels 32 should be displayed in a stopped state, is established, based upon an elapsed time after starting rotational display of the second video reels 32 (S23). If not (NO at S23), the main CPU 20 repeats the judgment at S23 while continuing rotational display of the second video reels 32. An elapsed time after starting rotational display of the second video reels 32 may be clocked using a timer (not shown), or alternatively, may be clocked by counting the number of clocks input from a clock generator (not shown) to the main CPU 20.

With respect to at least one of the second video reels 32, if a timing, with which the second video reel 32 should be displayed in a stopped state, is established (YES at S23), the main CPU 20 causes the second video reels 32 to be displayed in a stopped state so that the partial pattern determined at S15 with respect to the second video reel 32 to be displayed in a stopped state stops at the layout position determined at S15 (S24). Thus, the main CPU 20 at S24 outputs an appropriate control signal to the sub CPU 40 in accordance with the second reel identification information, partial-pattern identification information, and layout position information stored in the RAM 22, thereby displaying the second video reel 32 in a stopped state, via the sub CPU 40, the image control CPU 50, and the image control IC 54.

After the completion of the processing at S24, the main CPU 220 judges whether or not all of the three second video reels 32, 32, . . . are stopped (S25). If at least one of the second video reels 32 is still displayed in a rotating state (NO at S25), this CPU controls the routine to revert to S23 and judges a timing of stopping rotation of such video reel.

Where all of the three second video reels 32, 32, . . . have been stopped (YES at S25), the main CPU 20 judges whether or not a winning prize is established (S26). Thus, the main CPU 20 refers to the symbol table and base game-destined prize table, etc. stored in the ROM 21 and the second reel identification information and symbol identification information stored in the RAM 22, and then, judges whether or not specific symbols stop in the display area 11a. In further detail, this CPU judges whether or not at least three of the symbols of a same kind are displayed in a stopped state in the display area 11a.

Where a winning prize is established (YES at S26), the main CPU 20 controls a hopper 141 via a hopper driving circuit 142 to pay out a predetermined number of coins (S27), terminates base game play processing, and reverts to the former routine. If no winning prize is established (NO at S26), the main CPU 20 terminates base game play processing without executing the process at S27, and then, reverts to the former routine.

FIG. 18 is a flowchart showing a subroutine of procedures for executing feature game play processing in the game machine according to the first embodiment of the present invention. The main CPU 20 starts a feature game corresponding to an entire pattern completed in a base game, and then, causes the display area 11a of the first liquid crystal display panel 11 to display a feature game image (S31).

The main CPU 20 at S31 refers to a pattern table and an image table 2a, etc., and outputs to the sub CPU 40 a control signal which is indicative of starting a feature game at the gaming machine 1, thereby displaying a feature game image, via the image control CPU 50 and the image control IC 54. After executing the processing at S31, none of the second video reels 32, 32, . . . is displayed on the feature game image displayed in the display area 11a.

Next, the main CPU 20 determines a combination between a player's character and an enemy's character competing against each other, with referring to the image table 2a and feature game-destined prize table 2b, etc., stored in the ROM 21 (S32). Further, the main CPU 20 randomly determines a winning character from among the player's and enemy's characters determined at S32 (S33). In other words, the main CPU 20 randomly determines which of the player's and enemy's characters win a game. For example, if a “beach” pattern has completed in a base game, a player's character 33 and an enemy's character 34 are determined at S32, and the player's character 33 is determined to be a winning character at S33.

Determining which of the player's and enemy's characters wins a game is determining whether or not a winning prize is established. In order to determine a winning character, the main CPU 20 refers to the pattern table, image table 2a, feature game-destined prize table 2b, and feature game-destined random number table or the like, which were stored in the ROM 21, and employs the random numbers that were generated by the random number generating circuit 23 and sampled by the sampling circuit 24. The character determined at S33 is temporality stored in the RAM 22.

After the completion of the processing at S33, the main CPU 20 displays a matchup image which is indicative of the fact that the character determined at S33 wins a matchup between a player's character and an enemy's character, based upon the data stored in the image ROM 55 in association with the entire pattern completed in a base game (S34). Thus, the main CPU 20 at S34 refers to: the pattern table and image table 2a stored in the ROM 21; and the characters or the like stored in the RAM 22, and then, outputs an appropriate control signal to the sub CPU 40, thereby displaying a matchup image, via the sub CPU 40, the image control CPU 50, and the image control IC 54.

After executing the processing at S34, the matchup image displayed in the display area 11a is an image which is indicative of the fact that the player's and enemy's characters compete against each other while the entire pattern completed in a base game is used as a background, as shown in FIG. 7. Next, if the player's character wins a game, the image as shown in FIG. 8 is displayed in the display area 11a. If the enemy's character wins a game, the image as shown in FIG. 9 is displayed in the display area 11a. Further, the main CPU 20 judges whether or not the character determined at S33 is a player's character, i.e., whether or not the player's character wins a game (S35).

Where the character determined at S33 is a player's character (YES at S35), the main CPU 20 generates the prizes stored in the feature game-destined prize table 2b in association with the entire pattern completed in a base game and a combination between the player's and enemy's characters competing against each other at S34 (S36). Lastly, the main CPU 20 controls the hopper 141 via the hopper driving circuit 142 to pay out coins, the number of which is responsive to the prizes generated at S36 (S37), terminates feature game play processing, and then, reverts to the former routine.

If the character determined at S33 is an enemy's character (NO at S35), the main CPU 20 terminates feature game play processing without executing the processing at S36 and S37, and then, reverts to the former routine.

### Second Embodiment

While, in the gaming machine 1 of the first embodiment, the first video reels 31, 31, . . . and the second video reels 32, 32, . . . were displayed in the display area 11a of the first liquid crystal display panel 11, the gaming machine 1 of the present embodiment is provided with mechanical reels 61, 61, . . . which are equivalent to the first video reels 31, 31 . . . .

Hereinafter, differences between the gaming machine 1 of the present embodiment and that of the first embodiment will be explained, and like constituent elements corresponding to the first embodiment are designated by like reference numerals, and a duplicate explanation thereof is omitted.

### 2-1. Configuration of the Gaming Machine

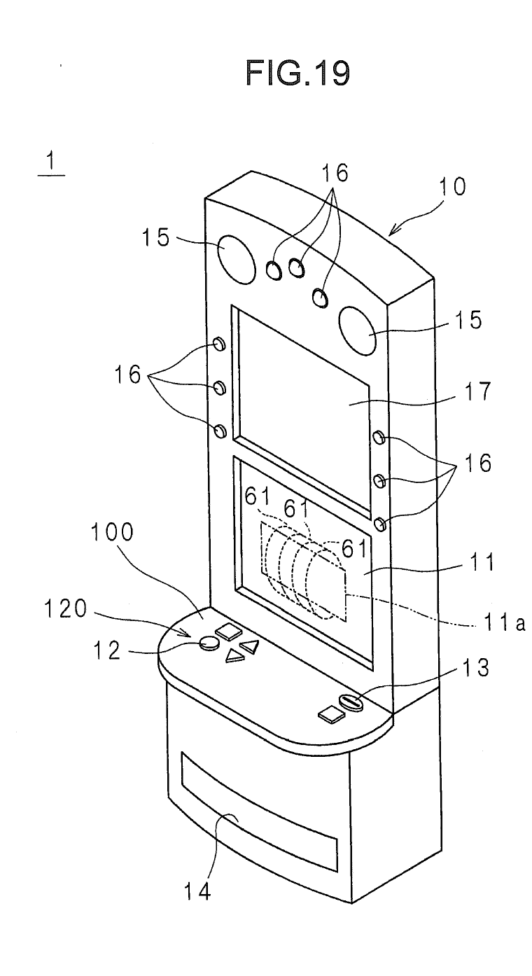

FIG. 19 is a perspective view showing an appearance of a gaming machine according to a second embodiment of the present invention. At the cabinet 10, at the depth side of the first liquid crystal display panel 11, mechanical reels 61, 61, . . . are housed so that an axially vertical direction coincides with a horizontal direction. Each of the mechanical reels 61 has dimensions for one square in the axially vertical direction, and is formed by employing a transparent or semitransparent cylindrical member. On the mechanical reels 61, 61, . . . , as is the case with the first video reels 31, 31, . . . , of the first embodiment, the partial patterns of respective ones of plural kinds of patterns, as shown in FIG. 3, are arranged. However, the transparency of the mechanical reels 61 is not extremely degraded by these partial patterns.

Although not shown, a light source serving as a backlight of the first liquid crystal display panel 11 is arranged inside of each of the mechanical reels 61, 61, . . . . The first liquid crystal display panel 11 is formed by employing a transparent liquid crystal display panel, and is opaque or semitransparent by varying the transmittance of a liquid crystal. In the display area 11a of the first liquid crystal display panel 11, the transmittance of the liquid crystal is set so that portions at which symbols of each of the second video reels 32 are arranged are opaque and portions at which they are not arranged are transparent. On the other hand, in a display area other than the transparent area 11a of the first liquid crystal display panel 11, the transmittance of the liquid crystal is set so that the corresponding portion is opaque.

As the result thereof, where the first liquid crystal display panel 11 is visually recognized from a frontal side, the second video reels 32, 32, . . . are displayed as if they were arranged in front of the mechanical reels 61, 61, . . . . In further detail, the second video reels 32, 32, . . . are displayed in the display area 11a so that the mechanical reels 61, 61, . . . cannot be transparently seen through the symbols arranged on each of the second video reels 32, whereas these reels can be transparently seen through portions at which the above symbols are not arranged. As the result thereof, a player can be readily visually recognize the partial patterns arranged on the mechanical reels 61, 61, . . . and the symbols arranged on the second video reels 32, 32, . . . in the display area 11a.

The player can see respective ones of the mechanical reels 61, 61, . . . as if they were rotating upwardly in the display area 11a. As the result thereof, the player can see symbols as if they were moving upwardly. At the frontal side of the mechanical reels 61, 61, . . . , the player can see respective ones of the second video reels 32, 32, . . . as if they were rotating rightward in the display area 11a. As the result thereof, the player can see symbols as if they were moving rightward.

On the other hand, the mechanical reels 61, 61, . . . cannot be transparently seen through a display area other than the display area 11a of the first liquid crystal display panel 11. Namely, the player cannot see the inside of the gaming machine 1 unnecessarily.

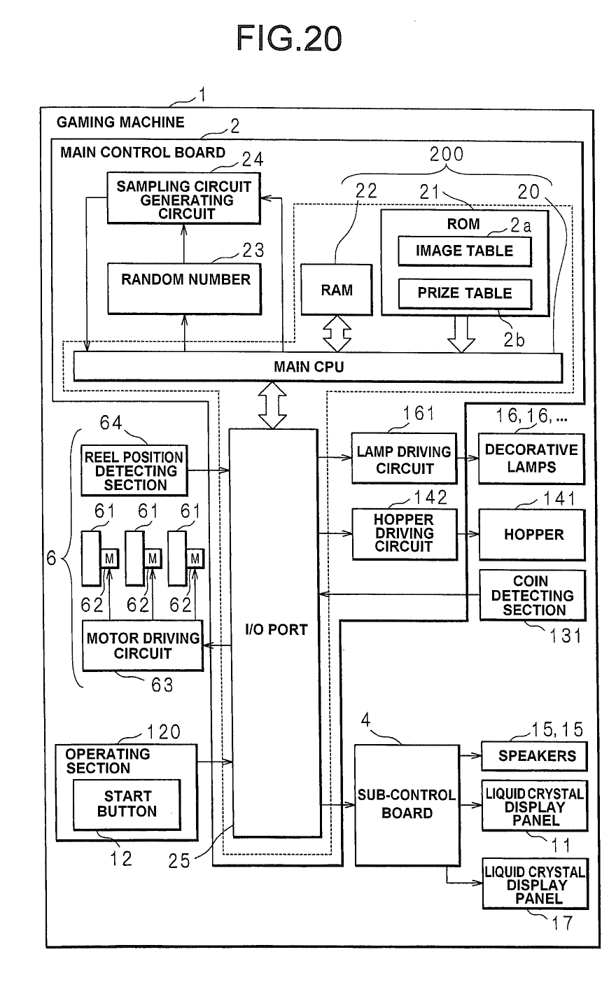

FIG. 20 is a block diagram depicting a configuration of essential portions of the gaming machine according to the second embodiment of the present invention. The gaming machine 1 of the present embodiment is further provided with a reel driving unit 6, and the reel driving unit 6 includes mechanical reels 61, 61, . . . , reel motors 62, 62, . . . , a motor driving circuit 63, and a reel position detecting section 64. The motor driving circuit 63 and the reel position detecting section 64 are connected to the I/O port 25, and the reel motor 62, 62, . . . are connected to the motor driving circuit 63. The reel motor 62 is coupled to each of the mechanical reels 61. The reel motor 62 is activated, whereby the mechanical reel 61 rotates, and the reel motor 62 is deactivated, whereby the mechanical reel 61 stops.

The motor driving circuit 63 is controlled by means of the main CPU 20, outputs a drive signal of each of the reel motors 62, 62, . . . , and stops output of the drive signal. Each of the reel motors 62 is activated where the drive signal is input, and is not activated if the signal is not input. The reel position detecting section 64 detects a rotational position of each of the mechanical reels 61, and then, outputs the detected position to the main CPU 20. The main CPU 20 stops each of the mechanical reels 61 at its required rotational position, based upon the detection result input from the reel position detecting section 64. As the result thereof, the partial patterns arranged on each of the mechanical reels 61 stop at their required layout positions.

Where the player operates the start button 12, the main CPU 20, to which the start signal was input from the operating section 120, starts rotation of each of the mechanical reels 61, via the motor driving circuit 63, and then, starts rotational display of each of the second video reels 32, via the sub-control board 4.

### 2-2. Operation of the Gaming Machine

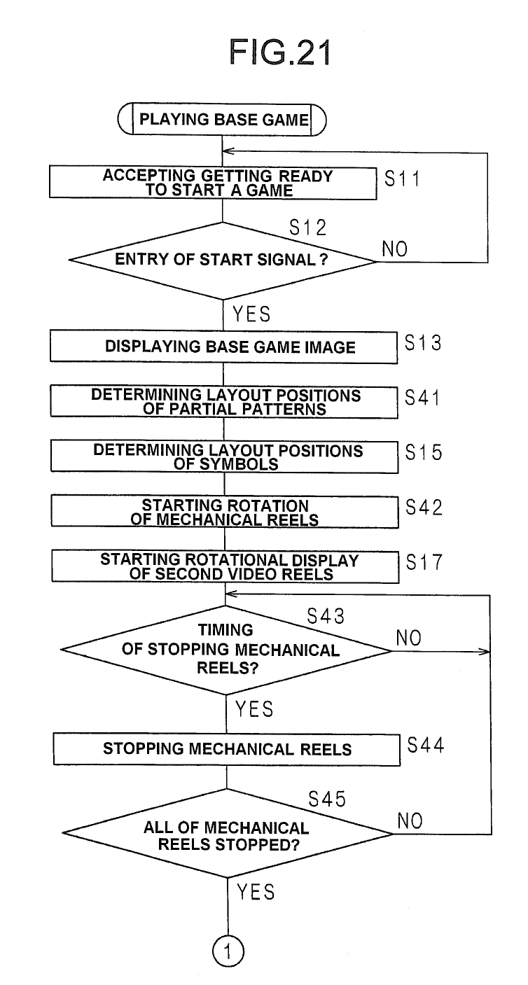

The game control processing implemented by the gaming machine 1 of the embodiment is identical to that shown in FIG. 16. Further, the feature game play processing implemented by the gaming machine 1 of the present embodiment is identical to that shown in FIG. 18. FIG. 21 is a flowchart showing a subroutine of procedures for executing base game play processing in the gaming machine according to the second embodiment of the present invention. This base game play processing is invoked and executed at S2 at which the game control processing shown in FIG. 16 is executed, instead of the subroutine of the base game play processing shown in FIGS. 17A and 17B. The processing operations at S11 to S13 and S15 and S17, according to the embodiment, are substantially identical to those shown in FIG. 17A. Therefore, a duplicate description thereof is omitted.

After executing the processing at S13, the main CPU 20 randomly determines the layout positions of partial patterns in correspondence with each of the mechanical reels 61 (S41), and then, executes the processing at S15. The layout positions of the partial patterns determined at S41 are vertical layout positions of partial patterns that should stop in a region corresponding to the display area 11a if rotation of each of the mechanical reels 61 stops. After the completion of the processing at S15, the main CPU 20 starts rotation of each of the mechanical reels 61 (S42), and then, executes the processing at S17. The main CPU 20 at S42 outputs an appropriate signal to the motor driving circuit 63. The motor driving circuit 63, to which this signal was input, outputs a drive signal to each of the reel motors 62, 62, . . . , whereby rotation of each of the mechanical reels 61 is started.

Further, the main CPU 20 judges whether or not a timing, with which rotation of each of the mechanical reels 61 should be stopped, is established, based upon an elapsed time after starting rotation of each of the mechanical reels 61 (S43). If not (NO at S43), the main CPU 20 repeats the judgment at S43 while continuing rotation of each of the mechanical reels 61. An elapsed time after starting rotation of each of the mechanical reels 61 may be clocked using a timer (not shown), or alternatively, may be clocked by counting the number of clocks input from a clock generator (not shown) to the main CPU 20.

With respect to at least one of the mechanical reels 61, where a timing, with which rotation of this mechanical reel 61 should be stopped, is established (YES at S43), the main CPU 20 stops the mechanical reel 61 so that the partial patterns determined at S41 with respect thereto stop at the layout positions determined at S41 (S44). Thus, the main CPU 20 at S44 stops signal output to the motor drive circuit 63. The motor drive circuit 63, to which this signal was not input, stops output of the drive signal to each of the reel motors 62, 62, . . . , whereby each of the mechanical reels 61 stops rotation.

After the completion of the processing at S44, the main CPU 20 judges whether or not all of the three mechanical reels 61, 61, . . . are stopped (S45). If at least one of the mechanical reels 61 is still rotating (NO at S45), this CPU controls the routine to revert to S43, and then, judges a timing of stopping rotation of such mechanical reel in action. If all of the three mechanical reels 61, 61, . . . have been stopped (YES at S45), the main CPU 20 executes the processes at the steps that are substantially identical to those at S21 to S27 shown in FIG. 17B.

### 2-3. Others

The configuration of the gaming machine of the present invention is not limitative to that of the gaming machine 1 of each of the first and second embodiments, and various modulations can occur without departing from the spirit of the invention. For example, probabilities of completing patterns, winning percentages of player's characters, and prizes awarded to players, etc., may be appropriately increased or decreased without being limitative to the numerical values of the embodiments. In addition, various numerical values may vary depending upon a predetermined condition while in the progress of a game. Further, the first video reels 31 may be rotationally displayed downwardly or horizontally, whereas the second video reels 32 may be rotationally displayed leftward or vertically.

What is claimed is:

1. A gaming machine, comprising:
a liquid crystal display section for displaying a plurality of first video reels, which rotate in one direction and on which partial patterns of respective ones of plural kinds of patterns are arranged, respectively, and a plurality of second video reels through which the first video reels can be transparently seen, which rotate in a direction crossing said one direction, and on which plural kinds of symbols are arranged, respectively;
an image storing section for storing data of an image indicating that a player's character and an enemy's character compete against each other in association with respective ones of plural kinds of patterns and either of the player's character and the enemy's character wins;
a prize storing section for storing a prize to be established, in association with respective ones of the plurality of patterns;
a start accepting section for accepting an operation of starting rotational display of the first video reels and rotational display of the second video reels; and
a processor, which executes processes of:
(a) starting a base game, and thereafter, randomly determining layout positions of partial patterns in correspondence with each of the first video reels, in a case where the start accepting section accepts the start operation;
(b) randomly determining layout positions of symbols in correspondence with each of the second video reels;
(c) rotationally displaying each of the first video reels;
(d) rotationally displaying each of the second video reels;
(e) displaying each of the first video reels in a stopped state, so that the partial patterns of each of the first video reels stop at the layout positions determined in the process (a);
(f) displaying each of the second video reels in a stopped state, so that the symbols of each of the second video reels stop at the layout positions determined in the process (b), in a case where one entire pattern is incomplete by the partial patterns stopping at the layout positions;
(g) establishing a prize corresponding to specific symbols, in a case where the symbols stopping thereat are the specific symbols;
(h) starting a feature game corresponding to one entire pattern, and thereafter, randomly determining which of the player's character and the enemy's character wins, in a case where said one entire pattern is completed by the partial patterns stopping at the layout positions;
(i) displaying an image indicating that the character determined at the process (h) wins, after the player's character and the enemy's character have competed against each other, based upon data stored in the image storing section in association with the completed entire pattern; and
(j) establishing a prize stored in the prize storing section in association with the completed entire pattern, in a case where the character determined in the process (h) is the player's character.

2. The gaming machine according to claim 1, wherein: the prize storing section stores a prize to be established, in association with respective ones of plural kinds of patterns and a combination of the player's character and the enemy's character; and
the process (j) is a process of establishing the prize stored in the prize storing section in association with the completed entire pattern and a combination of the player's character and the enemy's character competing against each other in the process (i), in a case where the character determined at the process (h) is the player's character.

3. A gaming machine, comprising:
a liquid crystal display section for displaying a plurality of first video reels, which rotate in one direction and on which partial patterns of respective ones of plural kinds of patterns are arranged, respectively, and a plurality of second video reels through which the first video reels can be transparently seen, which rotate in a direction crossing said one direction, and on which plural kinds of symbols are arranged, respectively;
an image storing section for storing data of an image indicating that a player's character and an enemy's character compete against each other in association with respective ones of plural kinds of patterns and either of the player's character and the enemy's character wins;
a prize storing section for storing a prize to be established, in association with respective ones of plural kinds of patterns and a combination of the player's character and the enemy's character;
a start accepting section for accepting an operation of starting rotational display of the first video reels and rotational display of the second video reels; and
a processor, which executes processes of:
(a) starting a base game, and thereafter, randomly determining layout positions of partial patterns in correspondence with each of the first video reels, in a case where the start accepting section accepts the start operation;
(b) randomly determining layout positions of symbols in correspondence with each of the second video reels;
(c) rotationally displaying each of the first video reels;
(d) rotationally displaying each of the second video reels;
(e) displaying each of the first video reels in a stopped state, so that the partial patterns of each of the first video reels stop at the layout positions determined in the process (a);
(f) displaying each of the second video reels in a stopped state, so that the symbols of each of the second video reels stop at the layout positions determined in the process (b), in a case where one entire pattern is incomplete by the partial patterns stopping at the layout positions;
(g) establishing a prize corresponding to specific symbols, in a case where the symbols stopping thereat are the specific symbols;
(h) starting a feature game corresponding to one entire pattern, and thereafter, randomly determining which of the player's character and the enemy's character wins, in a case where said one entire pattern is completed by the partial patterns stopping at the layout positions;
(i) displaying an image indicating that the character determined at the process (h) wins, after the player's character and the enemy's character compete against each other, based upon data stored in the image storing section in association with the completed entire pattern; and
(j) establishing a prize stored in the prize storing section in association with the completed entire pattern and a combination of the player's character and the enemy's character competing against each other in the process (i), in a case where the character determined in the process (h) is the player's character.

4. A gaming machine, comprising:
a plurality of mechanical reels, which rotate in one direction and on which partial patterns of respective ones of plural kinds of patterns are arranged, respectively;
a liquid crystal display section for displaying a plurality of video reels through which the mechanical reels can be transparently seen, which rotate in a direction crossing said one direction, and on which plural kinds of symbols are arranged, respectively;
an image storing section for storing data of an image indicating that a player's character and an enemy's character compete against each other, and either of the player's character and the enemy's character wins, in association with respective ones of plural kinds of patterns;
a prize storing section for storing a prize to be established, in association with respective ones of plural kinds of patterns;
a start accepting section for accepting an operation of starting rotation of the mechanical reels and rotational display of the video reels; and
a processor, which executes processes of:
(a) starting a base game, and thereafter, randomly determining layout positions of partial patterns in correspondence with each of the mechanical reels, in a case where the start accepting section accepts the start operation;
(b) randomly determining layout positions of symbols in correspondence with each of the video reels;
(c) rotating each of the mechanical reels;
(d) displaying each of the video reels in a rotating state;
(e) stopping each of the mechanical reels so that partial patterns of each of the mechanical reels stop at the layout positions determined in the process (a);
(f) displaying each of the video reels in a stopped state, so that symbols of each of the video reels stop at the layout positions determined in the process (b), in a case where one entire pattern is incomplete by the partial patterns stopping at the layout positions;
(g) establishing a prize corresponding to specific symbols, in a case where the symbols stopping thereat are the specific symbols;
(h) starting a feature game corresponding to one entire pattern, and thereafter, randomly determining which of the player's character and the enemy's character wins, in a case where said one entire pattern is completed by the partial patterns stopping at the layout positions;
(i) displaying an image indicating that the character determined at the process (h) wins, after the player's character and the enemy's character compete against each other, based upon data stored in the image storing section in association with the completed entire pattern; and
(j) establishing a prize stored in the prize storing section in association with the completed entire pattern and a combination of the player's character and the enemy's character competing against each other in the process (i), in a case where the character determined in the process (h) is the player's character.

5. A control method of a gaming machine which comprises:
a liquid crystal display section for displaying a plurality of first video reels which rotate in one direction and on which partial patterns of respective ones of plural kinds of patterns are arranged, respectively, and a plurality of second video reels through which the first video reels can be transparently seen, which rotate in a direction crossing said one direction, and on which plural kinds of symbols are arranged, respectively;
an image storing section for storing data of an image indicating that a player's character and an enemy's character compete against each other in association with respective ones of plural kinds of patterns and either of the player's character and the enemy's character wins;
a prize storing section for storing a prize to be established, in association with respective ones of the plurality of patterns; and
a start accepting section for accepting an operation of starting rotational display of the first video reels and rotational display of the second video reels,
said method including the steps of:
(a) starting a base game, and thereafter, randomly determining layout positions of partial patterns in correspondence with each of the first video reels, in a case where the start accepting section accepts the start operation;
(b) randomly determining layout positions of symbols in correspondence with each of the second video reels;
(c) rotationally displaying each of the first video reels;
(d) rotationally displaying each of the second video reels;
(e) displaying each of the first video reels in a stopped state, so that the partial patterns of each of the first video reels stop at the layout positions determined in the process (a);
(f) displaying each of the second video reels in a stopped state, so that the symbols of each of the second video reels stop at the layout positions determined in the process (b), in a case where one entire pattern is incomplete by the partial patterns stopping at the layout positions;
(g) establishing a prize corresponding to specific symbols, in a case where the symbols stopping thereat are the specific symbols;
(h) starting a feature game corresponding to one entire pattern, and thereafter, randomly determining which of the player's character and the enemy's character wins, in a case where said one entire pattern is completed by the partial patterns stopping at the layout positions;
(i) displaying an image indicating that the character determined at the process (h) wins, after the player's character and the enemy's character have competed against each other, based upon data stored in the image storing section in association with the completed entire pattern; and
(j) establishing a prize stored in the prize storing section in association with the completed entire pattern, in a case where the character determined in the process (h) is the player's character.
